(19) United States
(12) Patent Application Publication
(10) Pub. No.: US 2008/0213512 A1
(43) Pub. Date: Sep. 4, 2008

(54) Method for manufacturing cellulose ester film, and cellulose ester film, optical film, polarizing plate and liquid crystal display device using the same

(75) Inventors: Kazuaki Nakamura, Tokyo (JP); Kazuto Kiyohara, Tokyo (JP); Satomi Kawabe, Tokyo (JP); Akihiko Takeda, Kanagawa (JP); Yasushi Okubo, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KONICA MINOLTA OPTO, INC., Tokyo (JP)

(21) Appl. No.: 12/075,765

(22) Filed: Mar. 13, 2008

Related U.S. Application Data
(62) Division of application No. 11/227,782, filed on Sep. 15, 2005.

(30) Foreign Application Priority Data
Sep. 29, 2004 (JP) JP2004-284152

(51) Int. Cl. C09K 19/30; B32B 23/20

(52) U.S. Cl. 428/1.31; 428/532; 106/170.26

(57) ABSTRACT

A method for manufacturing a cellulose ester film comprising the steps of 1) mixing a cellulose ester exhibiting a water content of not greater than 3.0 weight %, at least one plasticizer selected from the groups A and B in an amount of one to thirty weight % of the cellulose ester, and at least one additive selected from the groups of C and D in an amount of 0.01 to 5 weight % of the cellulose ester to obtain a mixture, group A: ester plasticizers formed from a polyhydric alcohol and a monohydric carboxylic acid; group B: ester plasticizers formed from a polyhydric carboxylic acid and a monohydric alcohol; group C: hindered phenol anti-oxidants; group D: hindered amine light stabilizers, 2) heating to melt the mixture at a temperature (Tm) of between 150 and 300° C., and 3) forming a cellulose ester film with a melt casting method employing the melted mixture.

This application is a divisional of application Ser. No. 11/227,782 filed Sep. 15, 2005 (now pending).

### FIELD OF THE INVENTION

This invention relates to a method for manufacturing a cellulose ester film, and a cellulose ester film formed with a melt casting-method, and an optical film, a polarizing plate which uses the optical film as the polarizing plate protective film, and a liquid crystal display device using the polarizing plate.

### BACKGROUND OF THE INVENTION

Liquid crystal displays (LCDs) are widely used as display devices in products such as word processors and personal computers, television sets, monitors, and mobile information terminals because they can be directly connected to an IC circuit, operated at low voltage and low power consumption, and formed into thin devices. The basic structure of the LCD is comprised, for example, of a polarizing plate provided on both sides of a liquid crystal cell.

Incidentally, the polarizing plate only allows light of a fixed direction in the polarizing plane to pass. The LCD thus has the important role of making visible the changes in the orientation of the liquid crystal caused by an electric field. In other words, the performance of the polarizing plate greatly affects the performance of the LCD.

The polarizer of the polarizing plate is one in which iodine and the like is adsorbed on a high molecular weight polymer film and is then extruded. That is to say, a solution, called H ink which includes a two-colored substance (iodine), is adsorbed by wet adsorption onto a polyvinyl alcohol film and then the two-colored substance is oriented in one direction due to uniaxial extrusion of the film. Cellulose resin, and cellulose triacetate in particular, may be used as the polarizing plate protective film.

Cellulose ester film is optically and physically effective as a polarizing plate protective film and is thus widely used. However, because the method for manufacturing the film is a casting method using a halogen-based solvent, the cost required to recover the solvent is an extremely large negative factor. As a result, various solvents other than halogen-based solvent have been tried, but a substitute exhibiting sufficient solubility has not yet been discovered. Aside from attempts to find a substitute solvent, new dissolution methods such as cooling methods have been tried (See Patent Document 1 for example), but commercial viability has been slow and further research is needed. However, techniques for producing an optical cellulose ester film using a melt casting method that does not use solvents have been disclosed (See Patent Document 2 for example).

Further, techniques have also been disclosed in which spectral properties and mechanical properties are enhanced by increasing the ratio of the hindered phenol antioxidant, the hindered amine light stabilizer and the acid scavenger added to the cellulose ester (See Patent Document 3 for example). Techniques in which a polyhydric ester based plasticizer is used as the plasticizer (See Patent Document 4, for example), and techniques in which the polyhydric ester based plasticizer is limited to a specific structure (See Patent Document 5, for example) are also known. In both cases however, there is a rather high manufacturing load due to installation load for the optical cellulose ester film associated with the use of the solvent in the manufacturing process. As a result, the optical properties and mechanical properties of the cellulose ester film are insufficient.

Patent Document No. 1: Unexamined Japanese Patent Application Publication No. (hereinafter, referred to as JP-A) 10-95861

Patent Document No. 2: JP-A 2000-352620

Patent Document No. 3: JP-A 2003-192920

Patent Document No. 4: JP-A 2003-12823

Patent Document No. 5: JP-A 2003-96236

### SUMMARY OF THE INVENTION

The object of this invention is to provide a method for manufacturing a cellulose ester film in which the manufacturing load and installation load associated with drying and recovery of the essential solvent is reduced, and which also exhibits excellent optical properties and dimensional stability, as well as an optical film, a polarizing plate which uses the optical film as a polarizing plate protective film, and a liquid crystal display device which uses the polarizing plate.

The above objects of this invention are achieved by the structures described below.

(Item 1)

A method for manufacturing a cellulose ester film comprising the steps of:

1) mixing a cellulose ester exhibiting a water content of not greater than 3.0 weight %, at least one plasticizer selected from the following groups of A and B in an amount of 1-30 weight % of the cellulose ester, and at least one additive selected from the groups of C and D in an amount of 0.01-5 weight % of the cellulose ester to obtain a mixture,
group A: ester plasticizers formed from a polyhydric alcohol and a monohydric carboxylic acid
group B: ester plasticizers formed from a polyhydric carboxylic acid and a monohydric alcohol
group C: hindered phenol anti-oxidants
group D: hindered amine light stabilizers

2) heating to melt the mixture at a temperature (Tm) of between 150-300° C., and

3) forming a cellulose ester film with a melt casting method employing the above melted mixture.

(Item 2)

The method for manufacturing the cellulose ester film of Item 1, wherein the mixture contains two additives, each respectively from group C and from group D, and an added amount of each additive is 0.01-5 weight % of the cellulose ester.

(Item 3)

The method for manufacturing the cellulose ester film of Item 1 or 2, wherein an acid scavenger is incorporated in the mixture in an amount of 0.1-10 weight % of the cellulose ester.

(Item 4)

The method for manufacturing the cellulose ester film of any one of Items 1-3, wherein the cellulose ester is selected from the group consisting of cellulose acetate, cellulose propionate, cellulose butyrate, cellulose acetate propionate, cellulose acetate butyrate, cellulose acetate phthalate and cellulose phthalate.

(Item 5)

The method for manufacturing the cellulose ester film of any one of Items 1-4, wherein the ester plasticizer formed from the polyhydric alcohol and the monohydric carboxylic acid and the ester plasticizer formed from the polyhydric carboxylic acid and the monohydric alcohol are each an alkyl polyhydric alcohol aryl ester and a polyhydric carboxylic acid alkyl ester respectively.

(Item 6)

The method for manufacturing the cellulose ester film of any one of Items 1-5, wherein the hindered phenol anti-oxidant is a 2,6-dialkyl phenol derivative.

(Item 7)

The method for manufacturing the cellulose ester film of Items 1-6, wherein the hindered amine light stabilizer is a 2,2,6,6-tetraalkyl piperidine derivative.

(Item 8)

The method for manufacturing the cellulose ester film of any one of Items 3-7, wherein the acid scavenger is an epoxy compound.

(Item 9)

A cellulose ester film manufactured with the manufacturing method of any one of Items 1-8.

(Item 10)

An optical film comprising the cellulose ester film, wherein at least one layer-selected from the group consisting of an anti-static layer, a hard coat layer, an anti-reflection layer, a contact facilitating layer, an anti-glare layer, and an optical compensation layer, is applied on at least one side of the cellulose ester film of Item 9.

(Item 11)

A polarizing plate, wherein the cellulose ester film of Item 9 or the optical film of Item 10 is applied on at least one side of the polarizing plate.

(Item 12)

A liquid crystal display device comprising the polarizing plate of Item 11.

A cellulose ester film in which the manufacturing load and installation load associated with drying and recovery of the solvent, is reduced, and which exhibits excellent optical properties and dimensional stability, as well as an optical film, and a polarizing plate which uses the optical film as a polarizing plate protective film, and further a liquid crystal display device which uses the polarizing plate is provided by this invention.

### DETAILED DESCRIPTION OF THE INVENTION

The following is a detailed description of this invention.

This invention relates to a cellulose ester film obtained by melt casting using a cellulose ester exhibiting a water content not greater than 3.0 weight % and at least one type of an ester based plasticizer formed from a polyhydric alcohol and a monohydric carboxylic acid and/or an ester based plasticizer formed from a polyhydric carboxylic acid and a monohydric alcohol, with a hindered phenol antioxidant, a hindered amine light stabilizer, and an acid scavenger in the combination and addition ratios described in Items 1-6.

The solution casting method which is a method to manufacture the cellulose ester film, is one in which a solvent, in which the cellulose ester is dissolved, is cast, after which the solvent evaporates during drying to form the film. In this method, because the solvent remaining within the film must be removed, a drying line, drying energy and devices for recovering and recycling the evaporated solvent must be provided, leading to extremely high investment for installation and manufacturing, and reduction of these inherent costs is an important factor.

As a result, in film manufacture using the melt casting method, because no solvent is used for preparing the solution of the cellulose ester for melt casting, the drying load and installation load described above do not exist.

When the un-dried cellulose ester is formed into a film using the melt casting method, small bubbles are generated at the time of molding, resulting in deterioration of optical properties such as haze, transmittance, and retardation. By performing melt casting using a cellulose ester exhibiting water content not greater than 3.0 weight %, there is no haze as a result of reduced water content whereby optical properties are improved. Also by using an ester based plasticizer formed from a polyhydric alcohol and a monohydric carboxylic acid, and/or an ester based plasticized formed from a polyhydric carboxylic acid and a monohydric alcohol as the plasticizer, affinity to the cellulose ester is increased and as a result, optical and mechanical properties of the cellulose ester film are enhanced.

Further, in the case where cellulose ester film is prepared using the solution casting method, luminescent points of foreign matter are generated, while when the cellulose ester film is prepared using the melt casting method, the amount of generated luminance points of foreign matter generated is reduced.

Melt casting in this invention is defined as melting by heating to a temperature where the cellulose ester becomes fluid, without using a solvent, and then the fluid cellulose ester is cast to thereby perform melt casting. The methods for melting, when listed as specific methods, can be classified to include a melt extrusion molding method, a press molding method, an inflation method, an irradiation molding method, a blow molding method, and an extrusion molding method. Of these, the melt extrusion method is excellent to obtain an optical film with superior mechanical strength and superior surface accuracy. The method for manufacturing cellulose ester film of this invention includes the melt casting method of film formation, in which the materials comprising the film are heated, and when a fluid state is reached, the fluid is extruded on a drum or an endless belt to form the film.

### (Cellulose Ester)

The cellulose ester of this invention is a single or mixed acid ester of cellulose which has a cellulose ester structure including at least one of a fatty acid acyl group or a substituted or unsubstituted aromatic acyl group.

Examples of the benzene ring substituent group when the aromatic ring in the aromatic acyl group is a benzene ring include, a halogen atom, a cyano group, an alkyl group, a cycloalkyl group, an alkoxy group, and aryl group, an aryloxy group, an acyl group, a carbonamide group, a sulfonamide group, a ureido group, an aralkyl group, a nitro group, an alkoxy carbonyl group, an aryloxy carbonyl group, an aralkyoxy carbonyl group, a carbamoyl group, a sulfamoyl group, an acyloxy group, an alkenyl group, an alkinyl group, an alkyl sulfonyl group, an aryl sulfonyl group, an alkyloxy sulfonyl group, an aryloxy sulfonyl group, an alkyl sulfonyloxy group, and an aryloxy sulfonyl group, —S—R, —NH—CO—OR, —PH—R, —P(—R)₂, —PH—O—R, —P(—R) (—O—R), —P(—O—R)₂, —PH(═O)—R—P(═O) (—R)₂, —PH(═O)—O—R, —P(═O) (—R) (—O—R), —P(═O) (—O—R)₂, —O—PH(═O)—R, —O—P(═O) (—R)₂—O—PH(═O)—O—R, —O—P(═O) (—R)(—O—R), —O—P(═O) (—O—R)₂, —NH—PH(═O)—R, —NH—P(═O) (—R) (—O—R), —NH—P(═O) (—O—R)₂, —SiH₂—R, —SiH(—R)₂, —Si(—R)₃, —O—SiH₂—R, —O—SiH(—R)₂ and —O—Si(—R)₃. R above is a fatty acid group, an aromatic group, or a heterocyclic group. The number of substituent groups is preferably between 1 and 5, more preferably between 1 and 4 and still more preferably between 1 and 3, and most preferably either 1 or 2. Examples of the substituent group preferably include a halogen atom, cyano, an alkyl group, an alkoxy group, an aryl group, an aryloxy group, an acyl group, a carbonamide group, a sulfonamide group, and a ureido group, and more preferably, a halogen atom, cyano, an alkyl group, an alkoxy group, an aryloxy group, an acyl group, and a carbonamide group, and still more preferably, a halogen atom, cyano, an alkyl group, an alkoxy group, and an aryloxy group, and most preferably, a halogen atom, an alkyl group, and an alkoxy group.

Examples of the halogen atom include a fluorine atom, a chlorine atom, a bromine atom, and an iodine atom. The alkyl group may have ring structure or may be branched. The number of carbon atoms in the alkyl group is preferably 1-20, more preferably 1-12, still more preferably 1-6, and most preferably 1-4. Examples of the alkyl group include methyl, ethyl, propyl, isopropyl, butyl, t-butyl, hexyl, cyclohexyl, octyl and 2-ethyl hexyl. The alkoxy group may have ring structure or may be branched. The number of carbon atoms in the alkoxy group is preferably 1-20, more preferably 1-12, still more preferably 1-6, and most preferably 1-4. The alkoxy group may be further substituted by another alkoxy group. Examples of the alkoxy group include a methoxy, ethoxy, 2-methoxyethoxy, 2-methoxy-2-ethoxyethoxy, butyloxy, hexyloxy and octyloxy.

The number of carbon atoms in the aryl group is preferably 6-20, and more preferably 6-12. Examples of the aryl group include phenyl and naphtyl. The number of carbon atoms in the aryloxy group is preferably 6-20, and more preferably 6-12. Examples of the aryloxy group include phenoxy and naphtoxy. The number of carbon atoms in the acyl group is preferably 1-20, and more preferably 1-12. Examples of the acyl group include hormyl, acetyl, and benzoyl. The number of carbon atoms in the carbonamide group is preferably 1-20, and more preferably 1-12. Examples of the carbonamide include acetoamide and benzamide. The number of carbon atoms in the sulfonamide group is preferably 1-20, and more preferably 1-12. Examples of the sulfonamide include methane sulfonamide, benzene sulfonamide, and p-toluene sulfonamide. The number of carbon atoms in the ureido group is preferably 1-20, and more preferably 1-12. Examples of the ureido group include (unsubstituted) ureido.

The number of carbon atoms in the aralkyl group is preferably 7-20, and more preferably 7-12. Examples of the aralkyl group include benzyl, phenethyl, and naphtyl methyl. The number of carbon atoms in the alkoxycarbonyl group is preferably 1-20, and more preferably 2-12. Examples of the alkoxycarbonyl group include methoxy carbonyl. The number of carbon atoms in the aryloxy carbonyl group is preferably 7-20, and more preferably 7-12. Examples of the aryloxy carbonyl group include phenoxy carbonyl. The number of carbon atoms in the aralkyloxycarbonyl is preferably 8-20, and more preferably 8-12. Examples of the aralkyoxycarbonyl include benzyloxycarbonyl. The number of carbon atoms in the carbamoyl group is preferably 1-20, and more preferably 1-12. Examples of the carbamoyl group include (unsubstituted) carbamoyl and N-methyl carbamoyl. The number of carbon atoms in the sulfamoyl group is preferably no greater than 20, and more preferably no greater than 12. Examples of the sulfamoyl group include (unsubstituted) sulfamoyl and N-methyl sulfamoyl. The number of carbon atoms in the acyloxy group is preferably 1-20, and more preferably 2-12. Examples of the acyloxy group include acetoxy and benzoyloxy.

The number of carbon atoms in the alkenyl group is preferably 2-20, and more preferably 2-12. Examples of the alkenyl group include vinyl, aryl and isopropenyl. The number of carbon atoms in the alkinyl group is preferably 2-20, and more preferably 2-12. Examples of the alkinyl group include dienyl. The number of carbon atoms in the alkyl sulfonyl group is preferably 1-20, and more preferably 1-12. The number of carbon atoms in the aryl sulfonyl group is preferably 6-20, and more preferably 6-12. The number of carbon atoms in the alkyloxy sulfonyl group is preferably 1-20, and more preferably 1-12. The number of carbon atoms in the aryloxy sulfonyl group is preferably 6-20, and more preferably 6-12. The number of carbon atoms in the alkyl sulfonyloxy group is preferably 1-20, and more preferably 1-12. The number of carbon atoms in the aryloxy sulfonyl is preferably 6-20, and more preferably 6-12.

In the cellulose ester of this invention, in the case where the hydrogen atom of the hydroxyl group portion of the cellulose is a fatty acid ester with a fatty acid acyl group, the number of carbon atoms in the fatty acid acyl group is 2-20, and specific examples thereof include acetyl, propionyl, butyryl, isobutyryl, valeryl, pivaroyl, hexanoyl, octanoyl, lauroyl, stearoyl and the like.

The fatty acid acyl group of this invention also refers to one which is further substituted, and examples of the benzene ring substituent group include those given as examples when the aromatic ring in the aromatic acyl group is a benzene ring.

When the esterified substituent group of cellulose ester is an aromatic ring, the number of the substituent groups X which are substituted on the aromatic ring should be or 1-5, preferably 1-3, and 1 or 2 is particularly preferable. In addition, when the number of substituent groups substituted on the aromatic ring is 2 or more, the substituent groups may be the same or different from each other, and they may also bond with each other to form a condensed polycylic compound (such as naphthalene, indene, indan, phenanthrene, quinoline, isoquinilene, chromene, chromane, phthalazine, acridine, indole, indolin and the like).

The structure used in the cellulose ester of the present invention has a structure selected from at least one of a substituted or unsubstituted fatty acid acyl group or a substituted or unsubstituted aromatic acyl group, and these may be a single cellulose or a mixed acid ester, and two or more types of cellulose esters may be mixed and used.

The cellulose ester used in this invention is preferably at least one type selected from cellulose acetate, cellulose propionate, cellulose butyrate, cellulose acetate propionate, cellulose acetate butyrate, cellulose acetate phthalate and cellulose phthalate.

In terms of the degree of substitution for the mixed fatty acid ester, the short chain fatty acid ester of the cellulose acetate propionate, and cellulose acetate butyrate which are most preferable, have an acyl group having 2-4 carbon atoms as the substituent group, and given that the substituent group for the acetyl group is represented by X and the substituent group for the propionyl group or the butyryl group is represented by Y, the cellulose resin includes cellulose esters which simultaneously satisfy both Equation (I) and Equation (II) below.

2.6≦X+Y≦3.0 Equation (1)

0≦X≦2.5 Equation (II)

Cellulose acetate propionate is preferably used herein, and of the cellulose acetate propionates, those that satisfy 1.9≦X≦2.5 and 0.1≦Y≦0.9 are particularly preferable. The portion of the acyl group that is not substituted is usually a hydroxyl group. These may be synthesized by a known method.

In the cellulose ester used in this invention, the ratio of the weight average molecular weight Mw/number average molecular weight Mn is preferably 1.5-5.5, while 2.0-5.0 is particularly preferable, 2.5-5.0 is more preferable and 3.0-5.0 is even more preferable.

The cellulose which is the raw material for the cellulose ester of this invention may be wood pulp or cotton linter, and the wood pulp may be that of a needle-leaf tree or a broad-leaf tree, but that of the broad-leaf tree is more preferable. Cotton linter is preferably used in view of peeling properties at the time of film formation. Cellulose esters made from these substances may be suitably blended or used alone.

For example, the proportion used of cellulose ester from cotton linter: cellulose ester from wood pulp (needle-leaf tree): cellulose ester from wood pulp (broad-leaf tree) may be 100:0:0, 90:10:0, 85:15:0, 50:50:0, 20:80:0, 10:90:0, 0:100:0, 0:0:100; 80:10:10, 85:0:15, and 40:30:30.

### (Inclusion of Additives)

One or more types of additives is included in the cellulose ester having a water content not greater than 3.0 weight % of this invention prior to heat melting.

In the invention, including the additive does not only refer to the additive being enclosed by the cellulose ester, but also refers to the additive being present on the inside and the outer surface simultaneously.

The methods for including the additive include one in which the cellulose ester is dissolved in a solvent, and then the additive is dissolved or dispersed in the resultant solution, and then the solvent is removed. Known methods are used to remove the solvent, and examples thereof include the liquid drying method, the air drying method, the solvent co-precipitation method, the freeze-drying method, and the solution casting method. The mixture of the cellulose ester and the additive after the removal of the solvent can be prepared so as be in the form of a fine particles, granules, pellets, a film or the like. The inclusion of the additive is performed by dissolving solid cellulose ester as described above, but this may be performed simultaneously with deposition and hardening in the step of synthesizing the cellulose ester.

An example of the liquid drying method is one in which an aqueous solution of an activating agent such as sodium lauryl sulfate is added to a solution in which the cellulose ester and the acid are dissolved and an emulsion and dispersion is performed. Next, the solvent is removed by normal pressure or low pressure distillation, and a dispersant of the cellulose ester having the additive included therein is thereby obtained. In addition, centrifugal separation or decantation is preferably performed in order to remove the active agent. Various methods may be used as the emulsification method, and emulsification device using supersonic waves, high-speed rotational shearing and high pressure may be used.

In the emulsification and dispersion method using ultrasonic waves, a so-called batch method and continuous method may be used. The batch method is suitable for preparation of comparatively small amounts of sample, while the continuous method is suitable for large amounts of sample. In the continuous method, a device such as the UH-600SR (manufactured by SMT Co., Ltd.) may be used. In the case of the continuous method, the amount of time for the irradiation of the supersonic waves can be determined by the capacity of the dispersion chamber/flow rate×circulation frequency. In the case where there is more than one supersonic irradiation device, the total of each irradiation time is determined. The irradiation time for the supersonic waves is no more than 10,000 seconds. Also, if the irradiation time needs to be greater than 10,000 seconds, the processing load becomes large, and the actual emulsion dispersion time must be made shorted be re-selecting the emulsifying agent or the like. As a result, a time exceeding 10,000 seconds is not necessary. It is more preferable that the time is between 10 and 2,000 seconds.

A disperser mixer, a homogenizer, an ultra mixer or the like may be used as the emulsion and dispersion device which uses high-speed rotational shearing, and the viscosity of the liquid at the time of emulsion and dispersion can determine which type of device is used.

For emulsion and dispersion using high pressure, LAB 2000 (manufactured by SMT Co., Ltd.) may be used, but the emulsion and dispersion capability depends on the pressure that is applied to the sample. Pressure in the range of 10⁴-5×10⁵ kPa is preferable.

Examples of the active agent that may be used include a cation surface active agent, an anion surface active agent, an amphoteric surface active agent and a high molecular weight polymer dispersing agent. The active agent used is determined by the solvent and the particle diameter of the target emulsion.

The air drying method is one in which a spray dryer such as GS310 (manufactured by Yamato Scientific Co., Ltd.) is used, and a solution in which the cellulose ester and the additive are dissolved is sprayed.

The solvent co-precipitation method is one in which a solution in which the cellulose ester and the additive are dissolved is added to a poor solvent of the cellulose ester and the additive and then precipitation takes place. The poor solvent may be optionally blended with the solvent which dissolves the cellulose ester. The poor solvent may also be a mixed solvent. The poor solvent may also be added to a solution of the cellulose and the additive.

The mixture of the precipitated cellulose ester and the additive can be separated and dried and then separated.

In the mixture of the cellulose ester and the additive, the particle diameter of the additive is no greater than 1 μm and preferably no greater than 500 nm, and still more preferably no greater than 200 nm. The smaller the particle size of the additive, the more even the distribution of the mechanical strength and the optical properties of the melt cast, and thus a small particle size is favorable.

It is preferable that the mixture of the cellulose ester and the additives as well as the additives added at the time of heat melting are dried prior to or during heat melting. Drying herein refers to removing the water adsorbed by any of the melting materials, in addition to either the water or solvent used preparing the cellulose ester and additive mixture or the solvent introduced when preparing the additive.

The removal method may be any known drying method, and examples include the heating method, the pressure reduction method, the heating and pressure reduction method and the like, and may be performed in the air or in an inert gas environment with nitrogen selected as the inert gas. In view of film quality, it is preferable that these known drying methods are performed in a temperature range where the materials do not decompose.

For example, the moisture or solvent remaining after removal in the drying step is no greater than 10 weight % of the total weight of the materials comprising the film, and preferably no greater than 5 weight % and more preferably no greater than 1 weight %, and still more preferably no greater than 0.1 weight %. The drying temperature at this time is preferably between 100° C. and the Tg of the material to be dried. In view of preventing the materials from adhering to each other the drying temperature is preferably between 100° C. and the (Tg-5)° C. and more preferably between 110° C. and the (Tg-20)° C. The drying time is preferably 0.5-24 hours, and more preferably 1-18 hours and still more preferably 1.5-12 hours. If the drying time is less than these ranges, the level of drying will be low or the drying will take too much time. Also, if the material to be dried has a Tg, if it is heated to a drying temperature that is higher than Tg, the material melts and handling is difficult.

The drying stage may be separated into 2 or more stages. For example the melt film may be prepared via storage of the material using a preliminary drying step and a pre-drying step which is performed directly-before to one week before the melt layer is prepared.

(Additive)

Examples of the additives for the cellulose ester of this invention include at least one type of a polyhydric alcohol and a monohydric carboxylic acid, an ester based plasticizer formed from a polyhydric carboxylic acid and a monohydric alcohol, a hindered phenol antioxidant, a hindered amine light stabilizer, and an acid scavenger in the combinations described in claims 1-6. Other additives that may be included are peroxide compounds, radical scavengers, metal deactivators, ultraviolet light absorbers, matting agents, dyes, pigments, and plasticizers other than those described above, and antioxidants other than the hindered phenol antioxidants described above.

Additives are used to trap material generated when the materials composing the film are subjected to anti-oxidation and decomposition; to control or prevent the decomposition reaction caused by radicals due to heat or light as well as decomposition reactions of an unknown source; and to control generation of volatile components due to changed in quality typified by coloration and reduction in molecular weight.

On the other hand, when the materials comprising the film are melted using heat, the decomposition reaction is outstanding and deterioration in strength of the materials sometimes occurs due to coloration or reduction in molecular weight due to the decomposition. Generation of undesirable volatile components also occurs due to the decomposition reaction of the materials composing the film.

When the materials composing the film are melted using heat, the presence of the above-described additives is favorable because this controls deterioration of strength due to decomposition of the material, and also in view of the fact that characteristic strength of the material can be maintained. The foregoing additives must be present in order to produce the optical film of this invention.

In addition, the presence of the foregoing additives at the time of heat melting is favorable in that the creation of coloration in the visible region is controlled and also undesirable properties for the optical film such as transmissitivity or haze value caused by mixing of volatile components in the film can be controlled.

The displayed image of the liquid crystal display device of this invention is affected if haze exceeds 1% when the optical film having the structure of this invention is used, and thus the haze value is preferably less than 1% and more preferably less than 0.5%.

When the film is being produced, the step for providing retardation depends on controlling the deterioration in strength of the materials composing the film or maintaining the material characteristic of the film. This is because if the materials comprising the film become brittle due to extreme deterioration, breakage is likely to occur in the stretching step, and as a result it becomes impossible to control the retardation value.

A deterioration reaction due the oxygen in the air may occur during storage of the foregoing materials composing the film or during the film preparation step. In this case, the stabilizing effects of the foregoing additives and the effect of reducing the oxygen concentration in the air may be used together in realizing this invention. Examples of known techniques include using nitrogen or argon as the inert gas; degasification using conditions varying from reduced pressure to a vacuum; and an operating in an airtight environment. At least one of these three methods can be used in the presence of the foregoing additives. By decreasing the likelihood that oxygen in the air adheres to the material composing the film, deterioration of the material is controlled and this is favorable for achieving the object of this invention.

It is also favorable that the foregoing additives are present in the materials composing the film, in view of improving storage properties over time for the polarizing plate and the polarizer, comprising the polarizing plate of this invention, in order for the optical film of this invention to be used as a polarizing plate protective film.

In the liquid crystal display device using the polarizing plate of this invention, because the foregoing additives are present in the optical film of this invention, the storage properties of the optical film over passage of time is improved in view of control of the foregoing changes in quality or deterioration, and at the same time, the additives exhibit an excellent effect in improving the display quality of the liquid crystal display device, since the optical compensation design of the optical film can function over an extended period.

(Ester Based Plasticizer Formed from a Polyhydric Alcohol and a Monohydric Carboxylic Acid, and Ester Based Plasticizer Formed from a Polyhydric Carboxylic Acid and a Monohydric Alcohol)

Adding compounds generally known as plasticizers is favorable in view of modifying the film since it improves functional properties, imparts flexibility and resistance to water absorption, and reduces water transmittance. Also, in the heat casting method of this invention, the plasticizer is added to reduce the melting temperature of the materials composing the film to be lower than the respective glass transition temperature of the cellulose ester used. Also, at the same heating temperature, the viscosity of the materials composing the film including the plasticizer can be reduced to be less than that of the cellulose ester. In this invention, the melting temperature for the materials composing the film refers to the temperature at which the materials become liquid when the materials are sufficiently heated.

If the cellulose ester by itself is at a temperature that is less than its glass transition temperature, the fluid state for film formation is not exhibited. However, at a temperature higher than the glass transition temperature, the modulus of elasticity or the viscosity is reduced due to absorption of heat, and the fluid state is exhibited. In order to melt the materials composing the film, it is preferable that the plasticizer that is added has a melting point or glass transition temperature that is lower than the glass transition temperature of the cellulose ester in order to fulfill the above-cited objective. Further, it is preferable that the ester based plasticizer formed from polyhydric alcohol and a monohydric carboxylic acid and the ester based plasticizer formed from a polyhydric carboxylic acid and a monohydric alcohol have a high affinity for the cellulose ester.

This invention uses one or both of an ester based plasticizer formed from a polyhydric alcohol and a monohydric carboxylic acid and an ester based plasticizer formed from a polyhydric carboxylic acid and a monohydric alcohol.

Specific examples of an ethylene glycol ester based plasticizer of a polyhydric ester based plasticizer include; ethylene glycol alkyl ester based plasticizers such as ethylene glycol acetate, ethylene glycol butyrate and the like; ethylene glycol dicycloalkyl ester based plasticizers such as ethylene glycol dicyclopropyl carboxylate, and ethylene glycol dicyclohexyl carboxylate; and ethylene glycol aryl ester based plasticizers such as ethylene glycol dibenzoate, and ethylene glycol di-4-methyl benzoate. These alkylate groups, cycloalkylate groups and arylate groups may be the same or different and may further be substituted. The substituent groups may be a mix of alkylate groups, cycloalkylate groups and arylate groups, and the substituent groups may be bonded to each other by covalent linkage. Further, the ethylene glycol portions may be substituted and the ethylene glycol ester part of the structure may be part of the polymer or may be systematically included as a pendant. It may also be introduced into a part of the molecular structure of the additive such as an antioxidant, a acid scavenger, and a ultraviolet light absorber.

Examples of a glycerin ester based plasticizer, which is a polyhydric alcohol ester based plasticizer, include glycerin alky esters such as triaceetin, tributylin, glycerin diacetate carboxylate, and glycerin oleate propionate; glycerin cycloalkyl esters such as glycerin tricyclopropyl carboxylate, and glycerin tricyclohexyl carboxylate; glycerin aryl esters such as glycerin tribenzoate, and glycerin 4-methylbenzoate; diglycerin alkyl esters such as diglycerin tetraacetylate, diglycerin tetrapropionate, digylcerin acetate tricarboxylate, and diglycerin tetralaurate; diglycerin cycloalkyl esters such as diglycerin tetracylobutyl carboxylate, and diglycerin tetracylopentyl carboxylate; and diglycerin aryl esters such as diglycerin tetrabenzoate, and diglycerin 3-methyl benzoate. These alkylate groups, cycloalkyl carboxylate groups and arylate groups may be same or different and may further be substituted. The substituent groups may be a mix of alkylate groups, cycloalkyl carboxylate groups and arylate groups, and the substituent groups may be bonded to each other by common bonds. Further, the glycerin and diglycerin portions may be substituted and the glycerin ester or diglycerin ester part of the structure may be a part of the polymer or may be systematically included as a pendant. It may also be introduced into a part of the molecular structure of the additive such as the antioxidant, the acid scavenger, and the ultraviolet light absorber.

Other examples of other polyhydric alcohol ester based plasticizers are given in JP-A 2003-12823 from paragraphs 30-33.

These alkylate groups, cycloalkyl carboxylate groups and arylate groups may be same or different and may be further substituted. The alkylate groups, cycloalkyl carboxylate groups and arylate groups may be mixed, and the substituent groups may be bonded to each other by common bonds. Furthermore, the polyhydric alcohol portion may be substituted and polyhydric alcohol part of the structure may be a part of the polymer or may be systematically included as a pendant. It may also be introduced into a part of the molecular structure of the additive such as the antioxidant, the acid scavenger the ultraviolet light absorber and the like.

Of the ester based plasticizers formed from a polyhydric alcohol and a monohydric carboxylic acid, alkyl polyhydric alcohol aryl esters are preferable; specific examples include ethylene glycol benzoate, glycerin tribenzoate, diglycerin tetrabenzoate and compound 16 which is given as an example in paragraph 32 of JP-A 2003-12823.

Specific examples of the carboxylic acid ester based plasticizer which is a polyhydric carboxylic acid ester based plasticizer include alkyl dicarboxylic acid alkyl ester based plasticizers such as didodecyl moranate (Cl), dioctyl adipate (C4), dibutyl cevacate (C8) and the like; alkyl dicarboxylic acid cycloalkyl ester based plasticizers such as dicyclopentyl succinate, dicyclohexyl adipate and the like; alkyl dicarboxylic acid aryl ester based plasticizers such as diphenyl succinate, di-4-methyl phenyl glutarate and the like, cycloalkyl dicarboxylic acid alkyl ester based plasticizers such as dihexyl-1,4-cyclohexane dicarboxylate, didecyl bicyclo[2.2.1]heptane-2,3-dicarboxylate and the like; cycloalkyl dicarboxylic acid-dicycloalkyl ester based plasticizers such as dicyclohexyl-1,2-cyclobutane dicarboxylate, dicyclopropyl-1,2-cyclohexyl dicarboxylate and the like; cycloalkyl dicarboxylic acid aryl ester based plasticizers such as diphenyl 1,1-cyclopropyl dicarboxylate, di 2-naphtyl-1,4-cyclohexane dicarboxylate and the like; aryl dicarboxylic acid alkyl ester based plasticizers such as diethyl phthalate, dimethyl phthalate, dioctyl phthalate, dibutyl phthalate, di-2-ethyl hexyl phthalate and the like; aryl dicarboxylic acid cycloalkyl ester based plasticizers such as dicyclopropyl phthalate, dicyclohexyl phthalate and the like; and aryl carboxylic acid aryl ester based plasticizers such as diphenyl phthalate, di-4-methyl phenyl phthalate and the like. These alkoxy groups and cycloalkoxy groups may be the same or different, and may also be substituted and the substitution groups may be further substituted. The alkyl groups and the cycloalkyl groups may be mixed, and the substituent groups may be bonded to each other by common bonds. Furthermore, the aromatic ring of the phthalic acid may be substituted and may be polymer such as a dimer, trimer, tetramer and the like. The phthalic acid ester part of the structure may be a part of the polymer or may be systematically included as a pendant. It may also be introduced into a part of the molecular structure of the additive such as the antioxidant, and the acid scavenger the ultraviolet light absorber.

Specific examples of other polyhydric carboxylic acid ester plasticizers include alkyl polyhydric carboxylic acid alkyl ester based plasticizers such as tridodecyl tricarbalate, tributyl-meso-butane 1,2,3,4,-tetracarboxylate and the like, alkyl polyhydric carboxylic acid cycloalkyl ester based plasticizers such as tricyclohexyl tricarbalate, tricyclopopyl-2-hydroxy 1,2,3-propane tricarboxylate, alkyl polyhydric carboxylic acid aryl ester based plasticizers such as triphenyl 2-hydroxyl-1,2,3 propane tricarboxylate, tetra 3-methyl phenyl tetrahydrofuran 2, 3, 4, 5 tetracarboxylate and the like, cycloalkyl polyhydric carboxylic acid alkyl ester based plasticizers such as tetrahexyl-1,2,3,4-cyclobutane tetracarboxylate, tetrabutyl 1,2,3,4,-dicyclopentane tetracarboxylate and the like, cycloalkyl polyhydric carboxylic acid cycloalkyl ester based plasticizers such as tetracyclopropyl-1,2,3,4-cyclobutane tetracarboxylate, tricyclohexyl 1,3,5-cyclohexyl tricarboxylate and the like, cycloalkyl polyhydric carboxylic acid aryl ester based plasticizers such as triphenyl-1,3,5-cyclohexyl tricarboxylate, hexa 4-methyl phenyl-1,2,3,4,5,6-cyclohexyl hexacarboxylate and the like, aryl polyhydric carboxylic acid alkyl ester based plasticizers such as tridodecyl benzene-1,2,4-tricarboxylate, tetraoctyl benzene-1,2,4,5 tetracarboxylate and the like, aryl polyhydric carboxylic acid cycloalkyl ester based plasticizers such as tricyclopentyl benzene-1,3,5-tricarboxylate, tetracyclohexyl benzene-1,2,3,5 tetracarboxylate and the like, and aryl polyhdric carboxylic acid aryl ester based plasticizers such as triphenyl benzene-1,3,5-tetracarboxylate, hexa 4-methylphenyl benzene-1,2,3,4,5,6-hexacarboxylate and the like. These alkoxy groups and cycloalkoxy groups may be the same or different, and may also be substituted and the substitution groups may be further substituted. The alkyl groups and the cycloalkyl groups may be mixed, and the substituent groups may be bonded to each other by common bonds. Furthermore, the aromatic ring of the phthalic acid may be substituted and may be a polymer such as a dimer, trimer, tetramer and the like. The phthalic acid ester part of the structure may be a part of the polymer or may be systematically included as a pendant. It may also be introduced into a part of the molecular structure of the additive such as the antioxidant, the acid scavenger the ultraviolet light absorber and the like.

Of the ester based plasticizers formed from a polyhydric carboxylic acid and a monohydric alcohol, dialkyl carboxylic acid alkyl esters are preferable, specifically the foregoing dioctyl adipate and tridecyl carboxylate.

### (Other Plasticizers)

Other plasticizers that can be used in this invention include phosphoric acid ester based plasticizers, polymer plasticizers and the like.

Specific examples of the phosphoric acid ester based plasticizer include phosphoric acid alkyl esters such as triacetyl phosphate, tributyl phosphate and the like, phosphoric acid cycloalkyl esters such as tricyclopentyl phosphate, cyclohexyl phosphate and the like, phosphoric acid aryl esters such as triphenyl phosphate, tricresyl phosphate, cresylphenyl phosphate, octyldiphenyl phosphate, diphenylbiphenyl phosphate, trioctyl phosphate, tributyl phosphate, trinaphtyl phosphate, triglyceryl phosphate, tris ortho-biphenyl phosphate. The substituent groups for these maybe the same or different, and may be further substituted. The substituent groups may be a mix of alkyl groups, cycloalkyl groups and aryl groups, and the substituent groups may be bonded to each other by common bonds.

Examples of the phosphoric acid ester also include alkylene bis(dialkyl phosphates) such as ethylene bis (dimethyl phosphate), butylene bis(diethyl phosphate) and the like, alkylene bis(diaryl phosphates such as ethylene bis(diphenyl phosphate), propylene bis(dinaphtyl phosphate) and the like, arylene bis(dialkyl phosphates) such as phenylene bis(dibutyl phosphate), biphenylene bis(dioctyl phosphate) and the like, arylene bis(diaryl phosphates) such as phenylene bis(diphenyl phosphate), naphtylene bis (ditriyl phosphate) and the like. These substituent groups may the same or different, and may be further substituted. The substituent groups may be a mix of an alkyl group, cycloalkyl groups and aryl groups, and the substituent groups may be bonded to each other by common bonds.

Furthermore, a part of the structure of the phosphoric acid ester may be a part of the polymer or may be systematically included as a pendant. It may also be introduced into a part of the molecular structure of the additive such as the antioxidant, the acid scavenger, the ultraviolet light absorber and the like. Of the compounds listed above, aryl ester phosphates and arylene bis(diaryl phosphates) are preferable, and more specifically, triphenyl phosphate and phenylene bis(diphenyl phosphate) are preferable.

Specific examples of the polymer plasticizer include acrylic polymers such as an aliphatic hydrocarbon polymer, an alicyclic hydrocarbon polymer, polyacrylate ether, methyl polymethacrylate and the like, vinyl polymers such as polyvinyl isobutyl ether, poly N-vinyl pyrrolidone and the like, styrene polymers such as polystyrene, poly 4-hydroxy styrene and the like, polyesters such as polybutylene succinate, polyethylene terephthalate, polyethylene naphthalate and the like, polyethers such as polyethylene oxide, polypropylene oxide and the like, polyamides, polyurethanes, polyurea and the like. The number average molecular weight is preferably about 1,000-500,000 and 5,000-20,000 is particularly preferable. If the number average molecular weight is less than 1,000 there are problems with respect to volatility, while if it exceeds 500,000 the plasticizing properties decrease and the mechanical properties of the cellulose ester derivative composition are adversely affected. The polymer plasticizer may be a homopolymer formed by repeating the same kind of polymer units, or may be a copolymer having a structure in which there is a plurality of repeated units. In addition, 2 or more of the polymers may be used together.

### (Hindered Phenol Antioxidants)

By blending the hindered phenol antioxidant into the cellulose ester film, coloration or reduction in strength of the mold due to heat and deterioration caused by oxidation at the time of molding are prevented without reducing transparency and resistance to heat. Hindered phenol antioxidants may be used as the antioxidant in this invention. The hindered phenol antioxidant is a structure having a large branched alkyl group at the ortho position of the hydroxide group of the phenol compound.

Examples of the antioxidant include known hindered phenol antioxidant compounds such as 2-6-dialkyl phenol derivatives and the like which are described in columns 12-14 of the specification of U.S. Pat. No. 4,839,405. These compounds include those represented by the general formula (1) below.

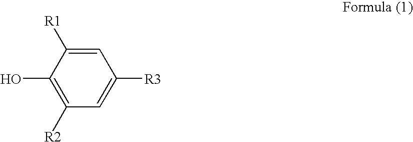

In the formula, R1, R2 and R3 represent an alkyl group substituent which may or may not be further substituted. Specific examples of the hindered phenol compound include n-octadyl 3-(3,5-di-t-butyl-4-hydroxyphenyl)-propionate, n-octadyl 3-(3,5-di-t-butyl-4-hydroxyphenyl)-acetate, n-octadecyl 3,5-di-t-butyl-4-hydroxybenzoate, n-hexyl 3,5-di-t-butyl-4-hydroxyphenylbenzoate, n-dodecyl 3,5-di-t-butyl-4-hydroxyphenylbenzoate, neo-dodecyl 3-(3,5-di-t-butyl-4-hydroxyphenyl)propionate, dodecyl β(3,5-di-t-butyl-4-hydroxyphenyl)propionate, ethyl α-(4-hydroxy 3,5-di-t-butylphenyl)isobutyrate, octadecyl α-(4-hydroxy 3,5-di-t-butylphenyl)isobutyrate, octadecyl α-(4-hydroxy 3,5-di-t-butyl-4-hydroxyphenyl)propionate, 2-(n-octylthio)ethyl 3,5-di-t-butyl-4-hydroxy-benzoate, 2-(n-octyl thio)ethyl 3,5-di-t-butyl-4-hydroxy-phenyl acetate, 2-(n-octadecyl thio)ethyl 3,5-di-t-butyl-4-hydroxy-phenyl-acetate, 2-(n-octadecyl thio)ethyl 3,5-di-t-butyl-4-hydroxy-benzoate, 2-(2-hydroxy ethyl thio)ethyl 3,5-di-t-butyl-4-hydroxy-benzoate, diethyl glycol bis(3,5-di-t-butyl-4-hydroxy-phenyl)propionate, 2-(n-octadecyl thio)ethyl 3-(3,5-di-t-butyl-4-hydroxy-phenyl)propionate, stearamide N,N-bis-[ethylene 3-(3,5-di-t-butyl-4-hydroxy-phenyl)propionate], n-butyl imino N,N-bis-[ethylene 3-(3,5-di-t-butyl-4-hydroxy-phenyl)propionate], 2-(2 stearoyloxyethylthio)ethyl 3,5-di-t-butyl-4-hydroxy benzoate, 2-(2-stearoyloxyethylthio)ethyl 7-(3-methyl-5-t-butyl-4-hydroxy-phenyl)heptanoate, 1,2-propylene glycol bis-[3-(3,5-di-t-butyl-4-hydroxy-phenyl)propionate], ethylene glycol bis-[3-(3,5-di-t-butyl-4-hydroxy-phenyl)propionate], neopentyl glycol bis-[3-(3,5-di-t-butyl-4-hydroxy-phenyl)propionate], ethylene glycol bis-(3,5-di-t-butyl-4-hydroxy-phenyl acetate), glycerine-1-n-octadecanoate-2,3-bis-(3,5-di-t-butyl-4-hydroxyphenyl acetate), pentaerythritol-tetrakis[3-(3′,5′-di-t-butyl-4′-hydroxy-phenyl)propionate], 1,1,1-trimethyrol ethane tris[3-(3,5-di-t-butyl-4-hydroxy-phenyl)propionate], sorbitol hexa-[3-(3,5-di-t-butyl-4-hydroxy-phenyl)propionate], 2-hydroxyyethyl 7-(3-methyl-5-t-butyl-4-hydroxy-phenyl)propionate, 2-stearoyloxyethyl 7-(3-methyl-5-t-butyl-4-hydroxy-phenyl)heptanoate, 1,6-n-hexane diole bis[(3′,5′-di-t-butyl-4-hydroxy-phenyl)propionate], pentaerythritol-tetrakis (3,5-di-t-butyl-4-hydroxy hydroxinamate). The hindered phenol based antioxidant compounds of the type listed above are commercially available as “Irganox 1076” and “Irganox 1010” manufactured by Ciba Specialty Chemicals.

### (Other Antioxidants)

Specific examples of other antioxidants used in this invention include phosphorous based antioxidants such as trisnonylphenyl phosphite, triphenyl phosphite, tris(2,4-di-tert-butylphenyl)phosphite and the like, sulfur based antioxidants such as dilauryl-3,3′-thiodipropionate, dimyristyl 3,3′ thiodipropionate, distearyl-3,3′-thiodipropionate, pentaerythritol-tetrakis(3-lauryl-thiopropionate) and the like, heat resistance process stabilizer such as 2-tert-butyl-6-(3-tert-butyl-2-hydroxy-5-methylbenzyl)-4-methyl phenyl acrylate, 2-[1-(2-hydroxy-3,5-di-tert-pentyl phenyl)ethyl]-4,6-di-tert pentyl phenyl acrylate and the like, compounds having a pyridine skeleton as part of the structure such as 3,4-di hydro-2H-1-benzopyrane based compounds, 3,3′ spirocycloman based compounds, 1,1 spiroindan based compounds, morpholine, thiomorpholine, thiomorpholine oxide, thiomorpholine dioxide, which are described in JP-A 8-27508, and acid scavengers such as dialkoxybenzene based compounds and the like which are described in JP-A 3-174150. The antioxidant part of the structure may be a part of the polymer or may be systematically included as a pendant. It may also be introduced into a part of the molecular structure of the additive such as the antioxidant, the acid scavenger, the ultraviolet light absorber and the like.

### (Hindered Amine Light Stabilizer)

The hindered amine light stabilizers are structures having a large organic group (such as a large branched alkyl group) in the vicinity of the N atom. These are known compounds and examples include 2,2,6,6-tetraalkyl piperidine compounds and the acid addition salts or the metal salt complexes thereof which are described in columns 5-11 of the specification of U.S. Pat. No. 4,619,956 and columns 3-5 of the specification of U.S. Pat. No. 4,839,405. Examples of these compounds include those represented by the general formula (2) below.

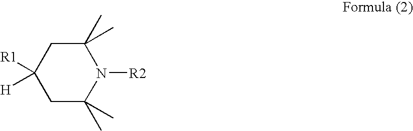

In the formula, R1 and R2 represent H or a substituent group. Specific examples of the hindered amine light stabilizers include 4-hydroxy-2,2,6,6-tetramethyl piperidine, 1-aryl-4-hydroxy 2,2,6,6-tetramethyl piperidine, 1-benzyl-4-hydroxy 2,2,6,6-tetramethyl piperidine, 1-(4-t-butyl-2-butenyl)-4-hydroxy 2,2,6,6-tetramethyl piperidine, 4-stearoyl oxy 2,2,6,6-tetramethyl piperidine, 1-ethyl-4-saliscyloyoxy, 2,2,6,6-tetramethyl piperidine, 4-metacryloyloxy-1,2,2,6,6-pentamethyl piperidine, 1,2,2,6,6-pentamethyl piperidine-4-yl-β (3,5 di-t-butyl-4-hydroxyphenyl)-propionate, 1-benzyl-2,2,6,6-tetramethyl-4-piperidinyl maleinate, (di 2,2,6,6-tetramethyl piperidine-4-yl)-adipate, (di 2,2,6,6-tetramethyl piperidine-4-yl)sepacate, (di 1,2,3,6-tetramethyl-2,6-diethyl-piperidine-4-yl)-sepacate, (di-1-aryl-2,2,6,6-tetramethyl-piperidine-4-yl)phthalate, 1-acetyl-2,2,6,6-tetramethyl-piperidine-4-yl acetate, trimellitic acid-tri-(2,2,6,6-tetramethyl-piperidine-4-yl)ester, 1-acryloyl-4-benzyloxy-2,2,6,6-tetramethyl-piperidine, dibutyl-malonic acid-di-(1,2,2,6,6-pentamethyl-piperidine-4-yl)-ester, dibenzyl-malonic acid di-(1,2,3,6-tetramethyl-2-6-diethyl piperidine-4-yl)-ester, dimethyl-bis-2,2,6,6-tetramethyl-piperidine-4-oxy)-silane, tris-(1-propyl-2,2,6,6-tetramethyl-piperidine-4-yl)phosphite, tris-(1-propyl-2,2,6,6-tetramethyl-piperidine-4-yl)phosphate, N—N′-bis-2,2,6,6-tetramethyl-piperidine-4-yl)-hexamethylene-1,6-diamine, tetrakis(2,2,6,6-tetramethyl-4-piperidyl)1,2,3,4-butanetetracarboxylate, tetrakis(1.2.2.6.6-pentamethyl-4-piperidyl)1,2,3,4-butanetetracarboxylate, N—N′-bis-2,2,6,6-tetramethyl-piperidine-4-yl)-hexamethylene-1,6-diacetamide, 1-acetyl-4-(N-cyclohexyl acetoamide)-2,2,6,6-tetramethyl-piperidine, 4-hexylamino-2,2,6,6-tetramethyl-piperidine, N—N′-bis-2,2,6,6-tetramethyl-piperidine-4-yl)-N—N′-dibutyl adipamide, N—N′-bis-(2,2,6,6-tetramethyl-piperidine-4-yl)-N—N′-dicyclohexyl-(2-hydroxypropylene), N—N′-bis-(2,2,6,6-tetramethyl-piperidine-4-yl)-p-xylelene-diamine, 4-(bis-2-hydroxyethyl)-amino-1,2,2,6,6-pentamethyl-piperidine, 4-methacrylamide 1,2,2,6,6-pentamethyl piperidine, α-cyano-β-methyl-β-[N-(2,2,6,6-tetramethyl-piperidine-4-yl)]-amino-methyl ester acrylate.

Examples of the preferable hindered amine light stabilizers include those represented by HALS-1 and HALS-2 below. Specific examples of HALS include the following high-molecular weight HALS, but are not limited to these examples; that is, high-molecular weight HALSs which are formed by plural piperidine rings bonding through triazine rings, such as N,N′,N″,N′″-tetrakis-[4,6-bis-{butyl-(N-methyl-2,2,6,6-tetramethylpiperidine-4-yl)amino}-triazine-2-yl]-4,7-diazadecane-1,10-diamine; a polycondensate (being CHIMASSORB 2020) of dibutylamine, 1,3,5-triazine-N,N′-bis(2,2,6,6-tetramethyl-4-piperidyl)-1,6-hexamethylenediamine and N-(2,2,6,6-tetramethyl-4-piperidyl)butylamine; a polycondensate of dibutylamine, 1,3,5-triazine, and N,N′-bis(2.2.6.6-tetramethyl-4-piperidyl)butylamine; poly[{(1,1,3,3-tetramethylbutyl)amino-1,3,5-triazine-2,4-diyl}{(2,2,6,6-tetramethyl-4-piperidyl)imino}hexamethylene{(2,2,6,6-tetramethyl-4-piperidyl)imino}] (e.g., CHIMASSORB 944); and a polycondensate of 1,6-hexanediamine-N,N-bis(2,2,6,6-tetramethyl-4-piperidyl), and morpholine-2,4,6-trichloro-1,3,5-triazine; and high-molecular weight HALSs which are formed by a piperidine ring bonding through an ester linkage, such as a polymer of dimethyl succinate and 4-hydroxy-2,2,6,6-tetramethyl-1-piperidine ethanol; a mixed esterified compound of 1,2,3,4-butanetetracarboxylic acid, 1,2,2,6,6-pentamethyl-4-piperidynol, and 3,9-bis(2-hydroxy-1,1-dimethylethyl)-2,4,8,10-tetraoxaspiro[5,5]undecane. Of these, preferable are such as a polycondensate of dibutylamine, 1,3,5-tritriazine and N,N′-bis(2,2,6,6-tetramethyl-4-piperidyl)butylamine; poly[{(1,1,3,3-tetramethylbutyl)amino-1,3,5-triazine-2,4-diyl}{(2,2,6,6-tetramethyl-4-piperidyl)imino}hexamethylene{(2,2,6,6-tetramethyl-4-piperidyl)imino}]; and a polymer of dimethyl succinate and 4-hydroxy-2,2,6,6-tetramethyl-1-piperidine ethanol; and also preferable are those having the number average molecular weight (Mn) of 2,000-5,000.

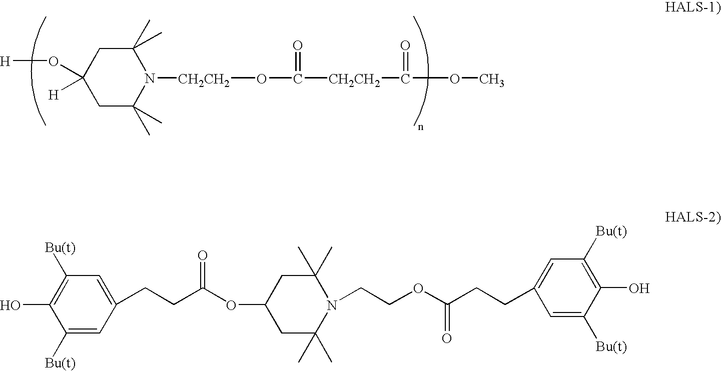

These hindered amine light stabilizers may be used singly or in combinations of 2 or more, and they may also be used with additives such as plasticizers, acid scavengers, ultraviolet light absorbers, or introduced into a part of the molecular structure of the additive.

### (Acid Scavengers)

The acid scavenger is an agent that has the role of trapping the acid (proton acid) remaining in the cellulose ester that is brought in. Also when the cellulose ester is melted, the side chain hydrolysis is promoted due water in the polymer and the heat, and in the case of CAP, acetic acid or propionic acid is formed. It is sufficient that the acid scavenger is able to chemically bond with acid, and examples include but are not limited to compounds including epoxy, tertiary amines, and ether structures.

Specific examples include an epoxy compounds which are acid trapping agents described in the specification of U.S. Pat. No. 4,137,201. The epoxy compounds which are trapping agents include those known in the technological field, and examples include polyglycols derived by condensation such as diglyceril ethers of various polygycols, especially those having approximately 8-40 moles of ethylene oxide per mole of polyglycol, diglyceril ethers of glycerol and the like, metal epoxy compounds (such as those used in the past in vinyl chloride polymer compositions and those used together with vinyl chloride polymer compositions), epoxy ether condensation products, a diglycidyl ether of Bisphenol A (namely 2,2-bis(4-glycidyloxyphenyl)propane), epoxy unsaturated fatty acid esters (particularly alkyl esters having about 4-2 carbon atoms of fatty acids having 2-22 carbon atoms (such as butyl epoxy stearate) and the like, and various epoxy long-chain fatty acid triglycerides and the like (such as epoxy plant oils which are typically compositions of epoxy soy bean oil and the like and other unsaturated natural oils (these are sometimes called epoxyified natural glycerides or unsaturated fatty acids and these fatty acids generally have 12 to 22 carbon atoms)). Particularly preferable are commercially available epoxy resin compounds, which include an epoxy group such as EPON 815c, and other epoxyified ether oligomer condensates such as those represented by the general formula (3).

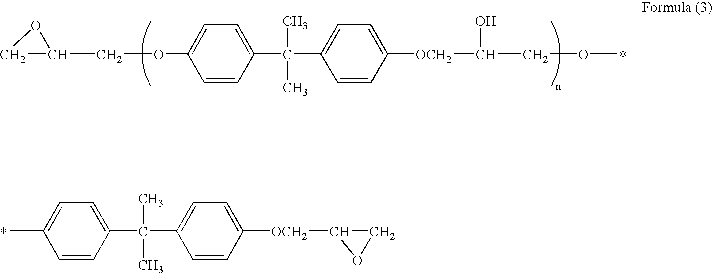

In the formula n is equal to 0-12. Other examples of acid trapping agents that can be used include those described in paragraphs 87-105 in JP-A 5-194788.

### (Ultraviolet Light Absorbers)

The ultraviolet light absorber preferably has excellent ultraviolet light absorbance for wavelengths not greater than 370 nm in view of preventing deterioration of the polarizer or the display device due to ultraviolet light, and from the viewpoint of the liquid crystal display it is preferable that there is little absorbance of visible light which has wavelength of not less than 400 nm. Examples of the ultraviolet light absorbers include oxybenzophenone compounds, benzotriazole compounds, salicylic acid ester compounds, benzophenone compounds, cyano acrylate compounds nickel complex compounds and the like and benzophenone compounds as well as benzotriazole compounds which have little coloration are preferable. In addition, the ultraviolet light absorbers described in JP-A Nos. 10-182621 and 8-337574, and the high molecular weight ultraviolet light absorbers described in JP-A 6-148430 may also be used.

Specific examples of the benzotriazole based ultraviolet light absorbers include 2-(2′-hydroxy-5′ methylphenyl)benzotriazole, 2-(2′-hydroxy 3′,5′-di-tert-butyl phenyl)benzotriazole, 2-(2′-hydroxy 3′-tert-butyl-5′-methylphenyl)benzotriazole, 2-(2′-hydroxy 3′,5′-di-tert-butyl phenyl)-5-chlorobenzotriazole, 2-(2′-hydroxy 3′-(3″,4″,5″,6″-tetrahydrophthalimide methyl)-5′-methylphenyl)benzotriazole, 2,2-methyl bis(4-(1,1,3,3,-tetramethyl butyl)-6-(2H-benzotriazole-2-yl)phenyl), 2-(2′-hydroxy-3′-tert-butyl-5′-methylphenyl)-5-chlorobenzotriazole, 2-(2H-benzotriazole-2-yl)-6-(straight chain or side chain dodecyl)-4-methylphenyl, and mixtures of octyl-3-[3-tert-butyl-4-hydroxy-5-(chloro-2H-benzotriazole-2-yl)phenyl]propionate and 2-ethylhexyl-3-[3-tert-butyl-4-hydroxy-5-(5-chloro-2H-benzotriazole-2-yl)phenyl]propionate. The benzotriazole based ultraviolet light absorber is however, not limited to these examples.

Commercially available TINUVIN 109, TINUVIN 171, and TINUVIN 360, which are manufactured by Chiba-Specialty Chemical Co., Ltd. may also be used as the benzotriazole based ultraviolet light absorber.

Examples of the benzophenone based compound include 2,4-hydroxy benzophenone, 2,2′-dihydroxy-4-methoxy benzophenone, 2-hydroxy-4-methoxy-5-sulfobenzophenone, bis (2-methoxy-4-hydroxy-5-benzoyl phenyl methane) and the like, but are not limited thereto.

The amount of the ultraviolet light absorber used in this invention is preferably 0.1-20 weight %, and more preferably 0.5-10 weight %, and still more preferably 1-5 weight %. Two or more of these may be used together.

### (Matting Agent)

Fine particles such as a matting agent or the like may be added to the polarizing plate protective film of this invention in order to impart a matting effect, and fine particles of inorganic compounds as well as fine particles of organic compounds may be used. The particles of the matting agent are preferably as fine as possible and examples of the fine particle matting agent include inorganic fine particles such as those of silicon dioxide, titanium dioxide, aluminum oxide, zirconium oxide, calcium carbonate, kaolin, talc, burned calcium silicate, hydrated calcium silicate, aluminum silicate, magnesium silicate, and calcium phosphate or cross-linked fine particles of high molecular weigh polymers of these, silicon dioxide is preferable in view of reduced haze in the film. The particles such as the silicon dioxide particles are often surface treated using an organic substance, and this is preferable because it reduces haze in the film.

Examples of the organic compound preferably used in the surface treatment include halogens, alkoxysilanes, silazanes, and siloxanes. Particles having a larger average particle diameter have a greater matting effect, while particles having a smaller average particle diameter have excellent transparency. The secondary particles should have an average primary particle diameter in the range of 0.05˜1.0 μm. The secondary particles preferably have an average primary particle diameter in the range of 5 to 50 nm, and more preferably 7 to 14 nm. These fine particles are preferable because they create unevenness of 0.01 to 1.0 μm in the plane of the cellulose ester film. The amount of the fine particles included in the cellulose ester is preferably 0.005-0.3 weight % of the cellulose ester.

Examples of the silicon dioxide particles include Aerosil 200, 200V, 300, R972, R972V, R974, R202, R812, OX50, or TT600 each manufactured by Nippon Aerosil Co., Ltd., and of these, Aerosil 200V, R972, R972V, R974, R202, and R812, are preferred. Two or more of these matting agents may be combined and used. In the case where 2 or more matting agents are used, they may be mixed in a suitably selected proportion. In this case, matting agents which have different particle diameter and quality such as Aerosil 200V and R972V may be used in weight proportions in the range from 0.1:99.9-99.9:0.1

The presence of the fine particles used as the matting agent in the film can also serve another purpose of improving the strength of the film. The presence of the fine particles in the film may also improve the orientation of the cellulose ester itself which composes the polarizing plate protective film of this invention.

### (Retardation Regulator)

In the polarizing plate protective film of this invention, the orientation film is formed and the liquid crystal layer is provided thereon. The retardation originating from the polarizing plate protective film and the liquid crystal layer are combined and optical compensation capability is imparted and polarizing plate processing is thereby performed such that the quality of the liquid crystal display is improved. The compounds added for regulating retardation include aromatic compounds having 2 or more aromatic rings which are described in the specification European Patent No. 911,656A2 which can be used as retardation regulators. Two or more of these compounds may be used together. The aromatic ring of these aromatic compounds may include aromatic heterocyclic rings in addition to aromatic hydrocarbon rings. The aromatic heterocyclic ring is preferable and the aromatic heterocyclic ring is generally an unsaturated heterocyclic ring. Of these, 1,3,5-triazine ring is particularly preferable.

### (High Molecular Weight Polymer Material)

High molecular weight polymer materials and oligomers other than cellulose ester may be suitably selected and mixed in the optical film of this invention. The abovementioned high molecular weight polymer materials and oligomers preferably have excellent compatibility with cellulose ester and the transmissivity when formed as a film is preferably 80% or more, more preferably 90% or more and still more preferably 92% or more. The object of mixing at least one or more of high molecular weight polymer materials and oligomers other than cellulose ester is also to regulate viscosity during heat melting and to improve the physical properties of the film after film processing. In this case, additives other than those described above may be added.

### (Film Preparation)

The polarizing plate protective film of this invention is prepared by referring the methods described in the specifications of U.S. Pat. Nos. 2,492,978, 2,739,070, 2,739,069, 2,492,977, 2,336,310, 2,367,603, and 2,607,704, English Patent Nos. 64,071 and 735,892, and Examined Japanese Patent Application Nos. (hereinafter, referred to as JP-B) 45-9074, 49-4554, 49-5614, 60-27562, 61-39890, and 62-4208.

For example, the mixture of the cellulose ester and the additives of this invention is subjected to hot air drying or vacuum drying and then subjected to melt extrusion, and then extruded as a film by a T-type die. The film is then placed in contact with a cooling drum using an electrostatic printing method and cold fixing is performed to obtain an unstretched film. The temperature of the cooling drum is preferably maintained at 90-150° C.

The melt extrusion may be performed using a uniaxial extruder, a biaxial extruder, or using a biaxial extruder which has a uniaxial extruder connected downstream thereof, but it is preferable that the uniaxial extruder is used in view of the mechanical strength and optical properties of the resulting film. Also, it is preferable that the usual ambient air supplied to the raw material tank, the raw material charge section and the extruder interior and during the melting process is replaced by an inactive gas such as nitrogen, or that the pressure of the ambient air is reduced.

The temperature during melt extrusion of this invention is typically to be in the range of 150-300° C., more preferably 180-270° C., but still more preferably 200-250° C. In cases when the temperature is less than 150° C., not only does too high a viscosity become a load to the molding machine (specifically motor load) or to its filter (being capable to operate under such high pressure), but optical characteristics of the film also deteriorate, such as transparency, streakings, or staining by adhesives at the die exit of the molding machine. When higher than 300° C., cellulose ester and additives are decomposed to result in reduced film strength such as the modulus of elasticity, and discoloration, which cause the film to be unviable as an optical film.

It is particularly preferable that in the case where a polarizing plate is prepared as the polarizing plate protective film for the optical film of this invention, the cellulose ester film is formed by stretching in the width direction or in the longitudinal direction in regard to film formation.

The film is preferably peeled from the cooling drum and the resulting unstretched film is heated in the range from the glass transition temperature (Tg) of the cellulose ester to Tg+100° C. via a heating device, such as a plurality of heated rollers and/or infrared ray heaters, and stretched in a single or a plurality of steps. Next, the obtained cellulose ester film which is stretched in the longitudinal direction as described above, is preferably also stretched in the lateral direction in the range of Tg to Tg-20° C., after which the heat-fixing is conducted.

In the case of lateral stretching, if the stretching is done while sequentially heating the film at a stretch zone that is divided into more zones which have a temperature difference of 1-50° C., distribution of physical properties in the horizontal direction is reduced, which is favorable. Also, if after lateral stretching, the film is maintained for 0.01-5 minutes between the final lateral stretching temperature and Tg-40° C., the distribution of physical properties in the horizontal direction is further reduced which is also advantageous.

Heat-fixing is normally done within a range-higher than the final lateral stretching temperature but not greater than Tg-20° C. for a period of 0.5-300 seconds. At that time, it is preferable that heat-fixing is done while sequentially increasing temperature in a stretch zone that is divided into two or more zones which have a temperature difference in the range of 1-100° C.

The film subjected to heat-fixing is usually cooled to a temperature less than the Tg, and the clip holding portion of both ends of the film is cut off and the film is wound up. At that time, it is preferable that a 0.1-10% relaxing process is performed in lateral and/or longitudinal direction at a range which is between the final heat-fixing temperature and the Tg. Also, cooling is preferably such that slow cooling from the final heat-fixing temperature to the Tg is achieved at a cooling rate not greater than 100° C. per second. The means for the slow cooling process is not particularly limited and can be performed by common known means, but it is particularly preferable to perform these processes while sequentially cooling in a plurality of temperature zones in view of improving the dimensional stability of the film. It is to be noted that, given that the final fixing temperature is T1 and the time for the film to reach Tg from the final heat-fixing temperature is “t”, the value for the cooling rate is determined by (T1−Tg)/t.

The optimal conditions for heat-fixing, cooling, and slow cooling processes differ depending on the cellulose ester comprising the film, and thus are determined by measuring the physical properties of the biaxially stretched film, and suitably adjusting the conditions to obtain favorable properties.

### (Functional Layers)

When the optical film of this invention is prepared, functional layers such as an antistatic layer, a hard coat layer, an anti-reflection layer, a matting facilitating layer, a contact facilitating layer, an anti-glare layer, a barrier layer, an optical compensation layer, or the like may be provided prior to and or after stretching. It is preferable that at least one layer selected from the anti-static layer, the hard coat layer, the anti-reflection layer, the contact facilitating layer, the antiglare layer and the optical compensation layer is provided. At that time, various surface treatments such a corona discharge treatment, plasma treatment, chemical treatment and the like may also be carried out, as appropriate.

In addition, after the clip holding portion of both ends of the film, that have been cut off, are subjected to a grinding process or granulation process as appropriate, it may be reused as material for the same or a different film.

A composition including cellulose resins, having differing concentrations of additives such as the plasticizer, ultraviolet light absorbers and the like as described above, may be co-extruded to prepare a layered structure cellulose ester film. For example, a cellulose ester film can be made so as to have the structure of a skin layer core layer/skin layer. A matting agent may be provided in a large amount in the skin layers or alternatively, may be only in either layer. The plasticizer and the ultraviolet light absorber may be provided in a larger amount in the core layer than in the outermost layer, or may be only in the core layer. The types of plasticizers and ultraviolet light absorbers in the core layer and the skin may be changed and a low volatility plasticizer and/or an ultraviolet light absorber may be added to the skin layer, while a plasticizer with excellent plasticity or an ultraviolet light absorber with excellent ultraviolet light absorbing properties may be added to the core layer. The Tg of the skin layer and the core layer may be different, and it is preferably that the Tg of the core layer is lower than that of a skin layer. Further, the viscosity of the melt including the cellulose ester at the time of melt casting may differ in the skin layer and the core layer, and the viscosity of the skin layer may be greater than the viscosity of the core layer, or the viscosity of the core layer may be greater than or equal to the viscosity of a skin layer.

The optical film of this invention may be used as a polarizing plate protective film. When used as polarizing plate protective film, the method for preparation of the film is not particularly limited, and it may be prepared by any of several commonly used methods. One example is one in which the obtained optical film is adhered to both surfaces of the polarizer using a completely saponified polyvinyl alcohol solution. The polarizers are prepared by being subjected to alkali treatment and then a polyvinyl alcohol film is immersed in an iodine solution and extrusion is performed. This method is favorable in view of the fact that the optical film which is the polarizing plate protective film of this invention is directly adhered to at least one surface of the polarizer.

A contact facilitating process such as those described in JP-A Nos. 6-94915 and 6-118232 may be performed instead of the above alkali processing.

The polarizing plate comprises the polarizer and the protective films which protect both sides of the polarizer. The polarizing plate may also be configured such that one protective film is adhered to one surface and a separating film is adhered to the opposite surface. The protective film and the separating film are to protect the polarizing plate during shipping and product inspection. At those times, the protective film is pasted on to protect the surface of the polarizing plate and is adhered on the opposite surface. The separating film is to cover the adhesion layer to which the liquid crystal plate is adhered, and is used on the surface to which the polarizing plate is pasted onto the liquid crystal cell.

### (Dimensional Stability)

It is preferable that the dimensional stability of the optical film of this invention is such that the dimensional variation is less than ±1.0% at 80° C. and 90% RH with the reference being the dimensions of the film left for 24 hours at 23° C. and 55% RH. A variation of less than 0.5% is more preferable while 0.1% is specifically preferable.

Regarding the optical film of this invention, used as a protective film for a polarizing plate, if the variation in the optical film itself exceeds the above range of dimensional stability, the absolute value of the retardation and the orientation angle of the polarizing plate will differ from that of the initial setting, which will result in reduced capacity for improvement in display quality, or deterioration of display quality.

### (Materials Composing the Film)

The presence of additives in the materials composing the film, such as the cellulose ester, plasticizer, antioxidant and others such as an ultraviolet light absorber, a matting agent and a retardation regulator which are added as appropriate, is favorable in view of preventing or controlling change in quality and deterioration of at least one of the materials comprising the film.

The amount of volatile components included when the materials composing the film are melted is not to be greater than 1 weight %, preferably not to be greater than 0.5 weight %, and more preferably not to be greater than 0.2 weight % and still more preferably not to be greater than 0.1 weight %. In this invention, the differential thermal weight from 30° C. to 350° C. is measured by a commercially available differential thermal weight analyzer, TG/DTA 200 (manufactured by Seiko Instruments Inc.), and this amount is used as the amount of integral volatile components.

### (Stretching Operation and Refractive Index Control)

The refractive index of the optical film of this invention may be controlled by appropriate stretching. If the stretching is performed by a factor of 1.0-2.0 in one direction of the cellulose ester and by a factor of 1.01-2.5 perpendicular to the interior of the plane of the film, the refractive index can be controlled within a desirable range.

For example, stretching can be done sequentially or simultaneously in the longitudinal direction of the film and perpendicular to that, or in other words the width direction. If at this time, the stretching factor in at least one direction is too small, a sufficient phase difference is not obtained, while if it is too large, the stretching is difficult and breakage sometimes occurs.

For example, in the case of stretching in the direction of casting after melting, if contraction in the width direction is too large, the refractive index in the thickness direction becomes too large. In this case, correction can be done by controlling the contraction in the width direction or by stretching in the width direction. In the case of stretching in the width direction, distribution of the refractive index in the width sometimes occurs. This is sometimes seen when the tenter method is used, but a contraction force is generated in the middle portion of the film by stretching in the width direction. This phenomenon occurs because the ends are fixed and is called the bowing phenomenon. In this case also, the bowing phenomenon can be controlled by stretching in the direction of casting, and distribution of the width direction phase difference is reduced to thereby achieve correction.

Furthermore, by stretching the film in the biaxial directions that cross each other, variation in film thickness can be reduced. If the variation in the thickness of the polarizing plate protective film is too large, there is unevenness in the phase difference and this poses a problem in terms of unevenness in coloration when used in a liquid crystal display.

The variation in the thickness of the cellulose ester film support is preferably in the range of ±3%, and more preferably ±1%. A method of extrusion in the biaxial directions which cross each other is effective in order to achieve objects such as those above, and the stretching is performed such that the final stretch factor for the biaxial directions which cross each other is in the range of 1.0-2.0 for the casting direction, and 1.01-2.5 for the width direction, and preferably 1.01-1.5 for the casting direction, and 1.05-2.0 for the width direction.

In the case where a cellulose ester is used which obtains positive birefringence with respect to stress, a slow axis for the optical film can be provided in the width direction by stretching in the width direction. In this case, it is preferable that the slow axis of the optical film is in the width direction in order to improve the display quality in this invention, and the stretching factor in the width direction must be greater than stretching factor in the casting direction.

The method for stretching the web is not particularly limited. Examples include, a method in which a plurality of rolls are caused to have differing peripheral speeds and stretching is done in the vertical direction by utilizing the difference in peripheral speed between the rolls; a method in which both ends of the web are fixed with clips or pins and the spaces between the pins or clips are extended in the forward direction to thereby carry out stretching in both the vertical and horizontal directions; a method in which widening in the width direction and stretching in the width direction are performed simultaneously; and a method in which widening in the vertical direction and stretching in the vertical direction are performed simultaneously. As a matter of course, these and other methods may be used in combination. In addition, in the case of the so-called tenter method, smooth stretching can be carried out by driving the clip portion using a linear driving method, and this method is favorable because it reduces the danger of breakage and the like.

Maintaining the width or stretching the width in the horizontal direction in the process of preparing the film is preferably performed by a tenter, and may be performed by a pin tenter or a clip tenter.

In the case where the optical film of this invention is used as a polarizing plate protective film, the thickness of the protective film is preferably 10-500 μm. In particular a thickness no less than 20 μm is preferable and no less than 35 μm is more preferable. Also a thickness no greater than 150 μm is preferable and no greater than 120 μm is more preferable. Particularly favorable is a thickness between 25 and 90 μm. If the optical film is thicker than the above range, it will be too thick after polarizing plate processing, and the thickness will be unsuitable for the liquid crystal displays used in notebook type personal computers and mobile electronic devices which, in particular, need to be thin and lightweight. On the other hand, if the optical film is thinner than the above-described range, expression of retardation will be difficult, and the water vapor permeability of the film will be high while the ability of the film to protect itself against humidity will be reduced.

The slow axis or the fast axis is present in the film plane and given that the angle formed in the direction of film formation is θ1, θ1 is preferably between −1° and +1°, and more preferably between −0.5° and +0.5°. θ1 can be defined as the orientation angle and can be measured using the automatic birefringence analyzer KOBRA-21ADH (manufactured by Oji Scientific Instruments).

If θ1 satisfies the above-described relationships, the displayed image will have a high luminance and this can contribute to the suppression or prevention of the escaping of light and thereby contribute to faithful color reproduction in the color liquid crystal display device.

### (Liquid Crystal Display Device)

A liquid crystal display device usually has disposed therein a substrate comprising a liquid crystal between two polarizing plates, but the polarizing plate protective film employing the optical film of this of this invention achieves excellent display properties regardless of where it is disposed. In particular, because a clear hard coat layer, an antistatic layer, an antireflection layer and the like are provided on the polarizing plate protective film which is the surface closest to the display side of the liquid crystal display device, it is preferable that the polarizing plate protective film is used at this portion.

### EXAMPLE

The following is a detailed description of this invention using examples, but the aspects of the invention are not to be limited by these examples. It is to be noted that “parts” hereinafter represents “parts by weight”.

### Example 1

### Preparation of Cellulose Ester Film Samples 1-1 to 1-17

Cellulose Ester C-1 (CAP-482-20 manufactured by Eastman Chemical Company) was dried in air for 2 hours at 130° C. and at ambient pressure and then cooled to room temperature. 1.0 part by weight and 0.5 part by weight of compound 4 and Sumilizer BP-76 respectively were added to the cellulose ester. The mixture was melted by heat to a melting temperature of 230° C. and then molded by melt extrusion using a T die, and then stretched at a stretching ratio of 1.2×1.2 at 160° C. As a result, a cellulose ester film sample 1-1 having a thickness of 80 μm was obtained. The water content was measured by a heat-drying type moisture analyzer, MOISTURE ANALYZER MX-50 manufactured by A&D Company, Ltd.

Inventive cellulose ester film samples 1-2, 1-3, 1-6, 1-7, 1-8, 1-11, 1-12, 1-14, 1-15, 1-16, and 1-17, and comparative cellulose ester film samples 1-4, 1-5, 1-9, 1-10 and 1-13 were prepared using exactly the same method except that the type of cellulose ester, the water content, the type of additives and the amount of additives were changed as shown in Table 1. The cellulose esters used in Comparative Samples 1-13 were subjected to humidity conditioning at 60° C. and 90% RH for 4 hours.

TABLE 1

| | | Water | | Amount | | Amount | |
|---|---|---|---|---|---|---|---|
| | Cellu- | Content | | (parts | | (parts | |
| Sample | lose | (weight | | by | Hindered | by | |
| No. | Ester | %) | Plasticizer | weight) | Phenol | weight) | Remarks |
| 1-1 | C-1 | 1.0 | Compound 4 | 1 | Sumilizer | 0.5 | This |
| | | | | | BP-76 | | invention |
| 1-2 | C-1 | 1.0 | Compound 4 | 5 | Sumilizer | 0.5 | This |
| | | | | | BP-76 | | invention |
| 1-3 | C-1 | 1.0 | Compound 4 | 30 | Sumilizer | 0.5 | This |
| | | | | | BP-76 | | invention |
| 1-4 | C-1 | 1.0 | Compound 4 | 0.5 | Sumilizer | 0.5 | Comparative |
| | | | | | BP-76 | | example |
| 1-5 | C-1 | 1.0 | Compound 4 | 50 | Sumilizer | 0.5 | Comparative |
| | | | | | BP-76 | | example |
| 1-6 | C-1 | 1.0 | Compound 12 | 5 | Tinuvin | 0.01 | This |
| | | | | | 120 | | invention |
| 1-7 | C-1 | 1.0 | Compound 12 | 5 | Tinuvin | 0.5 | This |
| | | | | | 120 | | invention |
| 1-8 | C-1 | 1.0 | Compound 12 | 5 | Tinuvin | 5 | This |
| | | | | | 120 | | invention |
| 1-9 | C-1 | 1.0 | Compound 12 | 5 | Tinuvin | 0.005 | Comparative |
| | | | | | 120 | | example |
| 1-10 | C-1 | 1.0 | Compound 12 | 5 | Tinuvin | 10 | Comparative |
| | | | | | 120 | | example |
| 1-11 | C-1 | 1.0 | Compound 16 | 5 | Tinuvin | 0.5 | This |
| | | | | | 1010 | | invention |
| 1-12 | C-1 | 3.0 | Compound 16 | 5 | Tinuvin | 0.5 | This |
| | | | | | 1010 | | invention |
| 1-13 | C-1 | 5.0 | Compound 16 | 5 | Tinuvin | 0.5 | Comparative |
| | | | | | 1010 | | example |
| 1-14 | C-1 | 1.0 | Di-2- | 8 | Sumilizer | 0.25 | This |
| | | | ethylhexyl- | | GA-80 | | invention |
| | | | adipate | | | | |
| 1-15 | C-1 | 1.0 | Dioctyl | 8 | Sumilizer | 0.25 | This |
| | | | sepacate | | GA-80 | | invention |
| 1-16 | C-2 | 1.0 | Compound 12 | 5 | Sumilizer | 0.5 | This |
| | | | | | BP-76 | | invention |
| 1-17 | C-2 | 1.0 | Dioctyl | 8 | Irganox | 0.25 | This |
| | | | sepacate | | 1010 | | invention |

Compound 4 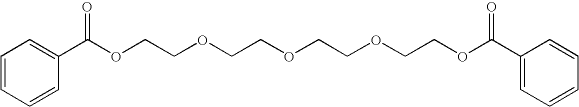
Compound 12 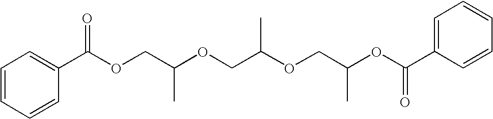
Compound 16 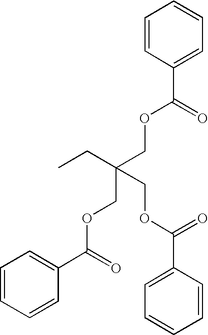
Di2-ethylhexyladipate 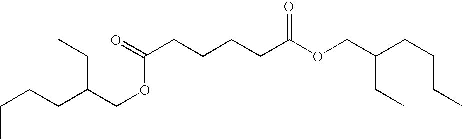
Dioctylsebacate 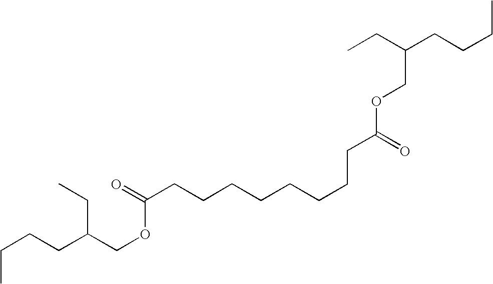
Sumilizer BP-76 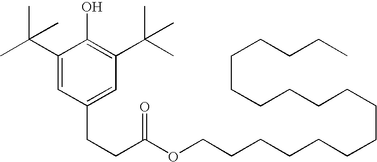
TINUVIN 120 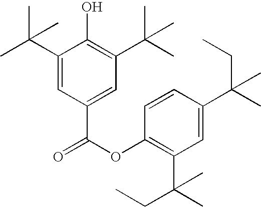
Sumilizer GA-80 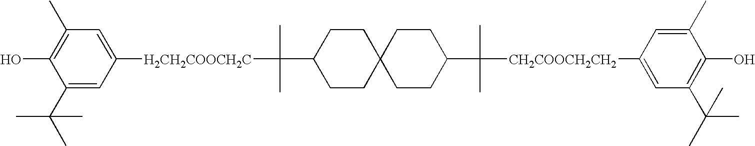
IRGANOX 1010

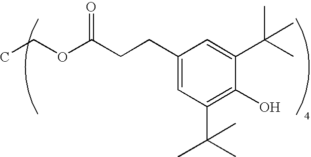

C-1: Cellulose Acetate Propionate CAP482-20 (manufactured by Eastman Chemical Company)

C-2: Cellulose. Acetate Butyrate CAB171-15 (manufactured by Eastman Chemical Company)

Samples 1-1, 1-2, 1-3, 1-6, 1-7, 1-8, 1-11, 1-12, 1-14, 1-15, 1-16, and 1-17 of this invention, and comparative samples 1-4, 1-5, 1-9, 1-10 and 1-13 which were prepared as described above, were evaluated as described in the following. The results are shown in Table 2.

### [Evaluation]

### (Haze)

The results of measuring haze using a haze meter (1001 DP model manufactured by Nippon Denshoku Industries Co., Ltd.) were converted to the haze value for the case where the thickness of the sample is 80 μm and displayed. The evaluation was such that haze less than 0.1% was indicated by A; haze from 0.1—less than 0.3% was indicated by B; haze from 0.3—less than 0.5% was indicated by C; haze from 0.5—less than 0.7% was indicated by D and haze exceeding 0.7% was indicated by DD.

### (Dimensional Stability)

Dimensional stability is indicated by the heat shrinkage rate. Three sample pieces of 30 mm width×120 mm length in the vertical direction and the transverse direction were taken. Holes with a diameter of 6 mm were formed with a punch in both ends of the sample pieces so as to have a distance of 100 mm between them. The sample pieces were subjected to humidity conditioning in a room with a temperatures of 23±3° C., and relative humidity of 65±5% for over 3 hours. The actual space between the punched holes (L₁) was measured to 1/1,000 mm accuracy the smallest unit of an automatic pin gauge (manufactured by Shinto Scientific Co., Ltd.). Next the test pieces were subjected to heat treatment for 3 hours in a thermostat at 801° C., and after the sample pieces were subjected to humidity conditioning in a room with a temperatures of 23±3° C., and relative humidity of 65±5% for over 3 hours, the actual space between the punched holes (L₂) was measured with the automatic pin gauge. The heat shrinkage rate was calculated using the formula below.

Heat shrinkage rate=(L₁−L₂/L₁)×100

The evaluation was such that a heat shrinkage rate less than 0.02% was indicated by A; a heat shrinkage rate from 0.02—less than 0.05% was indicated by B; a heat shrinkage rate from 0.05—less than 0.08% was indicated by C; a heat shrinkage rate from 0.08—less than 0.11% was indicated by D and a heat shrinkage rate exceeding 0.11% was indicated by DD.

### (Measurement of the Luminescent Foreign Materials)

Two polarizing plate samples were arranged in a crossed Nicol state and shielded from transmitted light and each sample was inserted between the two polarizing plates. A polarizing plate with a glass protective plate was used. Light was irradiated on one side of the sample and the number of luminescent points having a diameter of 0.01 mm or more per 1 cm² were counted from the opposite side using an optical microscope (magnification of 50). The evaluation was such that 0-30 luminescent points was indicated by A; 31-50 luminescent points was indicated by B; 51-80 luminescent points was indicated by C; 81-100 luminescent points was indicated by D, and luminescent points exceeding 101 was indicated by DD.

TABLE 2

| | | | Luminescent | |
|---|---|---|---|---|
| Sample | | Dimensional | Point Foreign | |
| No. | Haze | Stability | Material | Remarks |
| 1-1 | B | B | B | This invention |
| 1-2 | A | B | B | This invention |
| 1-3 | B | B | B | This invention |
| 1-4 | C | D | D | Comparative |
| | | | | example |
| 1-5 | D | C | C | Comparative |
| | | | | example |
| 1-6 | B | B | B | This invention |
| 1-7 | B | B | B | This invention |
| 1-8 | B | B | B | This invention |
| 1-9 | C | D | D | Comparative |
| | | | | example |
| 1-10 | D | D | D | Comparative |
| | | | | example |
| 1-11 | B | A | A | This invention |
| 1-12 | B | B | B | This invention |
| 1-13 | DD | DD | D | Comparative |
| | | | | example |
| 1-14 | A | B | B | This invention |
| 1-15 | A | B | B | This invention |
| 1-16 | B | B | B | This invention |
| 1-17 | A | B | A | This invention |

As is apparent from the above, the inventive samples 1-1, 1-2, 1-3, 1-6, 1-7, 1-8, 1-11, 1-12, 1-14, 1-15, 1-16, and 1-17 have better haze and dimensional stability and superior optical and mechanical properties when compared with the comparative samples, 1-10 and 1-13.

### Example 2

### Preparation of the Coating Composition

The following coating compositions were prepared.

(Antistatic layer coating composition (1))

| | |
|---|---|
| Polymethyl metacrylate (weight average | 0.5 part |
| molecular weight: 550,000; Tg: 90° C.) | |
| Propylene glycol monomethyl ether | 60 parts |
| Methyl ethyl ketone | 16 parts |
| Ethyl lactate | 5 parts |
| Methanol | 8 parts |
| Conductive polymer resin P-1 | 0.5 part |
| (0.1-0.3 μm particle size) | |

Conductive polymer resin P-1

| | |
|---|---|
| 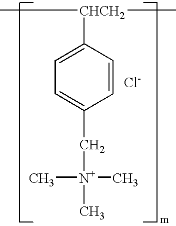 | 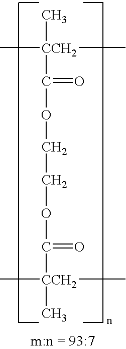 |

(Hard coat layer coating composition (2))

| | | |
|---|---|---|
| Dipentaerythritol hexaacrylate monomer | 60 | parts |
| Dipentaerythritol hexaacrylate dimer | 20 | parts |
| Dipentaerythritol hexaacrylate trimer and | 20 | parts |
| greater components | | |
| Diethoxybenzophenone photoreaction initiator | 6 | parts |
| Silicone surface active agent | 1 | part |
| Propylene glycol monomethyl ether | 75 | parts |
| Methyl ethyl ketone | 75 | parts |

(Anti-curl layer coating composition (3))

| | | |
|---|---|---|
| Acetone | 35 | parts |
| Ethyl acetate | 45 | parts |
| Isopropyl alcohol | 5 | parts |
| Diacetyl cellulose | 0.5 | part |
| Superfine particles of silica 2% acetone dispersion | 0.1 | part |
| (Aerosil 200V manufactured by Nippon Aerosil Co., Ltd.) | | |

Polarizing plate protective films that have been provided with function are prepared as described in the following.

### [Preparation and Evaluation of the Polarizing Plate Protective Film]

On one surface of optical film 1-21, which was prepared in the same manner as sample 1-1 in Table 1 except that the stretching ratio is 1.2 in the vertical direction×2.0 in the width direction, an anti-curl layer composition (3) is applied using gravure coating such that wet coat thickness was 13 μm, and then dried at a drying temperature of 80±5° C. The optical film sample 1-21A was thereby formed. The other surface of the cellulose ester film was coated with an antistatic layer coating layer composition (1) in a 28° C. and 82% RH environment at film conveyance speed of 30 m/min and a coating width of 1 m such the thickness of the wet film was 7 μm, and then dried at the drying section which was set at 80±5° C., and a resin layer with a dry film thickness of about 0.2 μm was provided, and a cellulose ester film with an antistatic layer was thereby provided. This formed the optical film sample 1-21B.

In addition, the hard coat layer coating composition (2) was coated on the antistatic layer such that the thickness of the wet film was 13 μm, and then dried at a drying temperature of 90° C., and then ultraviolet rays were irradiated at 150 mJ/m² and a clear hard coat layer having a dry thickness of 5 μm. These formed the optical film sample 1-21C.

The obtained optical film sample 1-21A, sample 1-21B, and sample 1-21C had favorable coating properties without brushing occurring or with out any cracking after drying.

Optical film samples of this invention 1-22A to C, 1-23A to C, 1-26A to C, 1-27A to C, 1-28A to C, 1-31A to C, 1-32A to C, 1-34A to C, 1-35A to C, 1-36A to C, and 1-37A to C, were prepared in the same manner as above except that the sample 1-1 of this invention was changed to samples 1-2, 1-3, 1-6, 1-7, 1-8, 1-11, 1-12, 1-14, 1-15, 1-16, and 1-17, and favorable coating properties were confirmed in all these samples.

For comparison, the same coating method was performed using optical film samples 1-4. The sample on which the anti-curl layer coating composition (3) was applied was called sample 1-24A; the sample on which the antistatic layer coating composition (1) was also applied was called 1-24B; and the sample on which the hard coat layer coating composition (2) was further applied to the antistatic layer was called 1-24C.

The results reveal that when coating was done in a high humidity environment, brushing occurred in sample 1-24A. Also, in the sample 1-24B, fine cracks after drying were sometimes seen and in sample 1-24C fine cracks after drying were obvious.

### [Preparation and Evaluation of the Polarizing Plate]

A 120 μm thick polyvinyl alcohol film was immersed in an aqueous solution comprised of 1 part by weight of iodine, 2 parts by weight of potassium iodide, 4 parts by weight of boric acid, and stretched at 50° C. by a factor of 4 to obtain a polarizer.

Inventive samples 1-1, 1-2, 1-3, 1-6, 1-7, 1-8, 1-11, 1-12, 1-14, 1-15, 1-16, and 1-17, and comparative samples 1-4, 1-5, 1-9, 1-10 and 1-13 were subjected to alkali treatment at 40° C. for 60 seconds in 2.5 M aqueous solution of sodium hydroxide and then washed in water and dried and the surface was thereby subjected to alkali treatment.

The surface of the inventive samples 1-1, 1-2, 1-3, 1-6, 1-7, 1-8, 1-11, 1-12, 1-14, 1-15, 1-16, and 1-17, and comparative samples 1-4, 1-5, 1-9, 1-10 and 1-13 that were subjected, to alkali treatment was adhered to both sides of the polarizer obtained above using a 5% completely saponified polyvinyl alcohol aqueous solution as an adhesive. The inventive polarizing plates 1-1, 1-2, 1-3, 1-6, 1-7, 1-8, 1-11, 1-12, 1-14, 1-15, 1-16, and 1-17, and comparative polarizing plates 1-4, 1-5, 1-9, 1-10 and 1-13 on which a polarizing film was formed were thereby prepared.

The inventive polarizing plates 1-1, 1-2, 1-3, 1-6, 1-7, 1-8, 1-11, 1-12, 1-14, 1-15, 1-16, and 1-17, had superior optical and physical properties and the degree of polarization was favorable compared to comparative polarizing plates 1-4, 1-5, 1-9, 1-10 and 1-13.

### [Evaluation of Properties as a Liquid Crystal Display Device]

The polarizing plate of a 15-inch TFT color liquid display LA-1529HM (manufactured by NEC Corporation) was peeled off and each of the polarizing plates prepared above were cut to fit the size of the liquid crystal display cell. Two polarizing plates prepared above were adhered with the liquid cell interposed therebetween, so as to cross each other without changing the original polarizing axis. The 15-inch TFT color liquid crystal display was thereby prepared and the properties as the polarizing plate of a cellulose ester film was evaluated. In the inventive polarizing plates 1-1, 1-2, 1-3, 1-6, 1-7, 1-8, 1-11, 1-12, 1-14, 1-15, 1-16, and 1-17, the contrast was higher and the display properties were superior when compared to comparative polarizing plates 1-4, 1-5, 1-9, 1-10 and 1-13. This confirms that the inventive polarizing plates are superior as the polarizing plate for an image display device such as a liquid crystal display.

### Example 3

Cellulose ester film sample 3-1 was prepared in the same manner as the cellulose ester film sample 1-1 of example 1, except that 0.5 parts by weight of Tinuvin 770 was used in place of 0.5 parts by weight of Sumilizer BP-76. Also inventive cellulose ester film samples 3-2, 3-3, 3-6, 3-7, 3-8, 3-11, 3-12, 3-14, 3-15, 3-16, and 3-17, and comparative cellulose ester film samples 3-4, 3-5, 3-9, 3-10 and 3-13 were prepared using the same method except that the type of cellulose ester, the water content, the type of additive and the amount of additive were changed as shown in Table 3. The evaluation was also carried out in the same manner as example 1.

TABLE 3

| | | Water | | Amount | | Amount | |
|---|---|---|---|---|---|---|---|
| | Cellu- | Content | | (parts | | (parts | |
| Sample | lose | (weight | | by | Hindered | by | |
| No. | Ester | %) | Plasticizer | weight) | amine | weight) | Remarks |
| 3-1 | C-1 | 1.0 | Compound 4 | 1 | Tinuvin | 0.5 | This |
| | | | | | 770 | | invention |
| 3-2 | C-1 | 1.0 | Compound 4 | 5 | Tinuvin | 0.5 | This |
| | | | | | 770 | | invention |
| 3-3 | C-1 | 1.0 | Compound 4 | 30 | Tinuvin | 0.5 | This |
| | | | | | 770 | | invention |
| 3-4 | C-1 | 1.0 | Compound 4 | 0.5 | Tinuvin | 0.5 | Comparative |
| | | | | | 770 | | example |
| 3-5 | C-1 | 1.0 | Compound 4 | 50 | Tinuvin | 0.5 | Comparative |
| | | | | | 770 | | example |
| 3-6 | C-1 | 1.0 | Compound 12 | 5 | CHIMASORB | 0.01 | This |
| | | | | | 944LD | | invention |
| 3-7 | C-1 | 1.0 | Compound 12 | 5 | CHIMASORB | 0.5 | This |
| | | | | | 944LD | | invention |
| 3-8 | C-1 | 1.0 | Compound 12 | 5 | CHIMASORB | 5 | This |
| | | | | | 944LD | | invention |
| 3-9 | C-1 | 1.0 | Compound 12 | 5 | CHIMASORB | 0.005 | Comparative |
| | | | | | 944LD | | example |
| 3-10 | C-1 | 1.0 | Compound 12 | 5 | CHIMASORB | 10 | Comparative |
| | | | | | 944LD | | example |
| 3-11 | C-1 | 1.0 | Compound 16 | 5 | ADKSTAB | 0.5 | This |
| | | | | | LA-52 | | invention |
| 3-12 | C-1 | 3.0 | Compound 16 | 5 | ADKSTAB | 0.5 | This |
| | | | | | LA-52 | | invention |
| 3-13 | C-1 | 5.0 | Compound 16 | 5 | ADKSTAB | 0.5 | Comparative |
| | | | | | LA-52 | | example |
| 3-14 | C-1 | 1.0 | Di-2- | 8 | CHIMASORB | 0.5 | This |
| | | | ethylhexyl- | | 2020FDL | | invention |
| | | | adipate | | | | |
| 3-15 | C-1 | 1.0 | Dioctyl | 8 | CHIMASORB | 0.5 | This |
| | | | sepacate | | 2020FDL | | invention |
| 3-16 | C-2 | 1.0 | Compound 12 | 5 | Tinuvin | 0.5 | This |
| | | | | | 770 | | invention |
| 3-17 | C-2 | 1.0 | Dioctyl | 8 | CHIMASORB | 0.5 | This |
| | | | sepacate | | 2020FDL | | invention |

TINUVIN 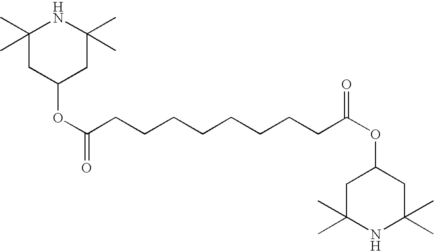
CHIMASSORB-944LD 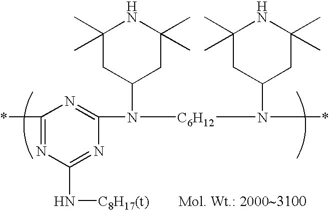
ADK STAB LA-52 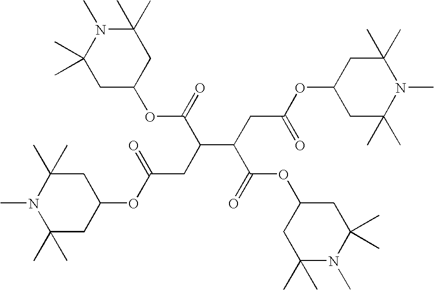
CHIMASSORB-2020FDL

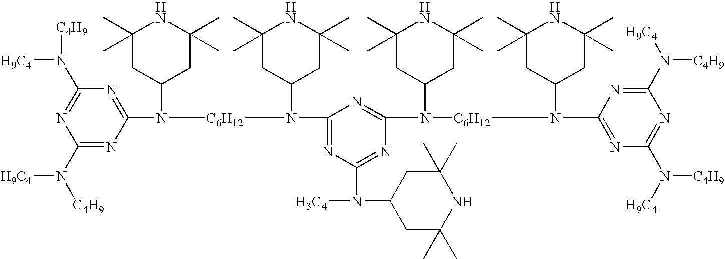

TABLE 4

| | | | Luminescent | |
|---|---|---|---|---|
| Sample | | Dimensional | Point Foreign | |
| No. | Haze | Stability | Material | Remarks |
| 3-1 | A | B | B | This invention |
| 3-2 | A | B | B | This invention |
| 3-3 | B | B | B | This invention |
| 3-4 | C | D | D | Comparative |
| | | | | example |
| 3-5 | D | C | C | Comparative |
| | | | | example |
| 3-6 | B | B | B | This invention |
| 3-7 | B | B | B | This invention |
| 3-8 | B | B | B | This invention |
| 3-9 | C | D | D | Comparative |
| | | | | example |
| 3-10 | D | D | D | Comparative |
| | | | | example |
| 3-11 | B | A | A | This invention |
| 3-12 | B | B | B | This invention |
| 3-13 | DD | DD | D | Comparative |
| | | | | example |
| 3-14 | B | B | B | This invention |
| 3-15 | B | B | B | This invention |
| 3-16 | A | B | B | This invention |
| 3-17 | B | B | B | This invention |

From Table 4, it is evident that haze and dimensional stability are better, and optical and mechanical properties of the inventive samples are excellent when compared with those of the comparative samples.

### Example 4

### Preparation and Evaluation of Polarizing-Plate Protective Film

Optical film samples 3-21A, 3-21B and 3-21C were obtained from optical film samples 3-21 which was prepared using sample 3-1 of Table 3 instead of sample 1-1 of Table 1 in the same manner as in preparation and evaluation of the polarizing film of example 2. These samples had favorable coating properties without brushing occurring and without any cracking after drying. In addition, it was confirmed that samples corresponding to 3-21A, 3-21B and 3-21C from other inventive samples in Table 3 all had favorable coating properties.

For comparison, optical film samples 3-24A, 3-24B, 3-24C were obtained from the optical film sample 3-24 which was prepared in the same manner using sample 3-4 in Table 3. The results revealed that when coating was done in a high humidity environment, brushing occurred in sample 3-24A. Also, in the sample 3-24B, fine cracks after drying were sometimes seen and in sample 3-24C fine cracks after drying were obvious.

### [Preparation and Evaluation of Polarizing Plate]

Inventive polarizing plates and the comparative polarizing plates were prepared in the same manner using the samples in Table 3 based on the preparation and evaluation of the polarizing plate in example 2, and the inventive polarizing plates had superior optical and physical properties and a more favorable degree of polarization when compared with the comparative polarizing plates.

### [Evaluation of Properties as a Liquid Crystal Display Device]

The 15-inch TFT color liquid crystal display was prepared in the same manner as in example 2, and the properties as the polarizing plate of a cellulose ester film were evaluated, and in the inventive polarizing plates prepared as described above, as expected, the contrast was higher and the display properties were excellent when compared to comparative polarizing plates also prepared as described above. This confirms that the inventive polarizing plates are excellent as the polarizing plate for an image display device such as a liquid crystal display.

### Example 5

Cellulose ester film sample 5-1 was prepared in the same manner as the cellulose ester film sample 1 of example 1, except that 0.25 parts by weight of Sumilizer BP-76 and 0.25 parts by weight of Tinuvin 770 were used in place of 0.5 parts by weight of Sumilizer BP-76. Also inventive cellulose ester film samples 5-2, 5-3, 5-6, 5-7, 5-8, 5-9, 5-10-, 5-13, 5-14, 5-16, 5-17, 5-18, and 5-19 and comparative cellulose ester film samples 5-4, 5-5, 5-11, 5-12 and 5-15 were prepared using the same method except that the type of cellulose ester, the water content, the type of additive and the amount of additive were changed as shown in Table 5. The evaluation was also carried out in the same manner as example 1.

TABLE 5

| | | Water | | Amount | | Amount | | Amount | |
|---|---|---|---|---|---|---|---|---|---|
| | Cellu- | Content | | (parts | | (parts | | (parts | |
| Sample | lose | (weight | | by | Hindered | by | Hindered | by | |
| No. | Ester | %) | Plasticizer | weight) | Phenol | weight) | amine | weight) | Remarks |
| 5-1 | C-1 | 1.0 | Compound 4 | 1 | Sumilizer | 0.25 | Tinuvin | 0.25 | This |
| | | | | | BP-76 | | 770 | | invention |
| 5-2 | C-1 | 1.0 | Compound 4 | 5 | Sumilizer | 0.25 | Tinuvin | 0.25 | This |
| | | | | | BP-76 | | 770 | | invention |
| 5-3 | C-1 | 1.0 | Compound 4 | 30 | Sumilizer | 0.25 | Tinuvin | 0.25 | This |
| | | | | | BP-76 | | 770 | | invention |
| 5-4 | C-1 | 1.0 | Compound 4 | 0.5 | Sumilizer | 0.25 | Tinuvin | 0.25 | Comparative |
| | | | | | BP-76 | | 770 | | example |
| 5-5 | C-1 | 1.0 | Compound 4 | 50 | Sumilizer | 0.25 | Tinuvin | 0.25 | Comparative |
| | | | | | BP-76 | | 770 | | example |
| 5-6 | C-1 | 1.0 | Compound 12 | 5 | Tinuvin | 0.01 | CHIMASORB | 0.25 | This |
| | | | | | 120 | | 944LD | | invention |
| 5-7 | C-1 | 1.0 | Compound 12 | 5 | Tinuvin | 0.25 | CHIMASORB | 0.25 | This |
| | | | | | 120 | | 944LD | | invention |
| 5-8 | C-1 | 1.0 | Compound 12 | 5 | Tinuvin | 5 | CHIMASORB | 0.25 | This |
| | | | | | 120 | | 944LD | | invention |
| 5-9 | C-1 | 1.0 | Compound 12 | 5 | Tinuvin | 0.25 | CHIMASORB | 0.01 | This |
| | | | | | 120 | | 944LD | | invention |
| 5-10 | C-1 | 1.0 | Compound 12 | 5 | Tinuvin | 0.25 | CHIMASORB | 5 | This |
| | | | | | 120 | | 944LD | | invention |
| 5-11 | C-1 | 1.0 | Compound 12 | 5 | Tinuvin | 0.003 | CHIMASORB | 0.003 | Comparative |
| | | | | | 120 | | 944LD | | example |
| 5-12 | C-1 | 1.0 | Compound 12 | 5 | Tinuvin | 7 | CHIMASORB | 7 | Comparative |
| | | | | | 120 | | 944LD | | example |
| 5-13 | C-1 | 1.0 | Compound 16 | 5 | Irganox | 0.25 | ADKSTAB | 0.25 | This |
| | | | | | 1010 | | LA-52 | | invention |
| 5-14 | C-1 | 3.0 | Compound 16 | 5 | Irganox | 0.25 | ADKSTAB | 0.25 | This |
| | | | | | 1010 | | LA-52 | | invention |
| 5-15 | C-1 | 5.0 | Compound 16 | 5 | Irganox | 0.25 | ADKSTAB | 0.25 | Comparative |
| | | | | | 1010 | | LA-52 | | example |
| 5-16 | C-1 | 1.0 | Di-2- | 8 | Sumilizer | 0.25 | CYASORBUV- | 0.25 | This |
| | | | ethylhexyladipate | | GA-80 | | 2020FDL | | invention |
| 5-17 | C-1 | 1.0 | Dioctyl sepacate | 8 | Sumilizer | 0.25 | CYASORBUV- | 0.25 | This |
| | | | | | GA-80 | | 2020FDL | | invention |
| 5-18 | C-2 | 1.0 | Compound 12 | 5 | Sumilizer | 0.25 | Tinuvin | 0.25 | This |
| | | | | | BP-76 | | 770 | | invention |
| 5-19 | C-2 | 1.0 | Dioctyl sepacate | 8 | Irganox | 0.25 | CHIMASORB | 0.25 | This |
| | | | | | 1010 | | 2020FLD | | invention |

TABLE 6

| | | | Luminescent | |
|---|---|---|---|---|
| Sample | | Dimensional | Point Foreign | |
| No. | Haze | Stability | Material | Remarks |
| 5-1 | A | B | B | This invention |
| 5-2 | A | B | B | This invention |
| 5-3 | B | B | B | This invention |
| 5-4 | C | D | D | Comparative |
| | | | | example |
| 5-5 | D | C | C | Comparative |
| | | | | example |
| 5-6 | B | B | B | This invention |
| 5-7 | B | B | B | This invention |
| 5-8 | B | B | B | This invention |
| 5-9 | B | B | B | This invention |
| 5-10 | B | B | B | This invention |
| 5-11 | C | D | D | Comparative |
| | | | | example |
| 5-12 | D | D | D | Comparative |
| | | | | example |
| 5-13 | DD | DD | D | This invention |
| 5-14 | B | B | B | This invention |
| 5-15 | DD | DD | D | Comparative |
| | | | | example |
| 5-16 | B | B | B | This invention |
| 5-17 | B | B | B | This invention |
| 5-18 | A | B | B | This invention |
| 5-19 | B | B | A | This invention |

From Table 6, it is evident that haze and dimensional stability are better, and optical and mechanical properties of the inventive samples are excellent when compared with those of the comparative samples.

### Example 6

### Preparation and Evaluation of Polarizing Plate Protective Film

Optical film samples 5-21A, 5-21B and 5-21C were obtained from optical film sample 5-21 which was prepared using sample 5-1 of Table 5 instead of sample 1-1 of Table 1 in the same manner as in preparation and evaluation of the polarizing film of example 2. These samples had favorable coating properties without brushing occurring and without any cracking after drying. In addition, it was confirmed that samples corresponding to 5-21A, 5-21B and 5-21C from other inventive samples in Table 5 all have favorable coating properties.

For comparison, optical film samples-5-24A, 5-24B, 5-24C were obtained from the optical film sample 5-24 which was prepared in the same manner using sample 5-4 in Table 5. The results reveal that when coating was done in a high humidity environment, brushing occurred in sample 5-24A. Also, in the sample 5-24B, fine cracks after drying were sometimes seen and in sample 5-24C fine cracks after drying were obvious.

### [Preparation and Evaluation of Polarizing Plate]

Inventive polarizing plates and the comparative polarizing plates were prepared in the same manner using the samples in Table 5 based on the preparation and evaluation of the polarizing plate in example 2, and the inventive polarizing plates had superior optical and physical properties and a more favorable degree of polarization when compared with the comparative polarizing plates.

### [Evaluation of Properties as a Liquid Crystal Display Device]

The 15-inch TFT color liquid crystal display was prepared in the same manner as in example 2, and the properties as the polarizing plate of a cellulose ester film was evaluated, and in the inventive polarizing plates prepared as described above, as expected, the contrast was higher and the display properties were excellent when compared to comparative polarizing plates also prepared as described above. This confirms that the inventive polarizing plates are excellent as the polarizing plate for an image display device such as a liquid crystal display.

### Example 7

Cellulose ester film sample 7-1 was prepared in the same manner as the cellulose ester film sample 1-1 of example 1, except that 0.25 parts by weight of Sumilizer BP-76 and 3 parts by weight of D-VII-3 were used in place of 0.5 parts by weight of Sumilizer BP-76. Also inventive cellulose ester film samples 7-2, 7-3, 7-6, 7-7, 7-8, 7-11, 7-12, 7-14, 7-15, 7-16, 7-19, 7-20, and 7-21 and comparative cellulose ester film samples 7-4, 7-5, 7-9, 7-10, 7-13, 7-17 and 7-18 were prepared using exactly the same method except that the type of cellulose ester, the water content, the type of additive and the amount of additive are changed as shown in Table 7. The evaluation was also carried out in the same manner as example 1.

TABLE 7

| | | Water | | Amount | | Amount | | Amount | |
|---|---|---|---|---|---|---|---|---|---|
| | Cellu- | Content | | (parts | | (parts | | (parts | |
| Sample | lose | (weight | | by | Hindered | by | Acid | by | |
| No. | Ester | %) | Plasticizer | weight) | Phenol | weight) | scavenger | weight) | Remarks |
| 7-1 | C-1 | 1.0 | Compound 4 | 1 | Sumilizer | 0.25 | D-VII-3 | 3 | This |
| | | | | | BP-76 | | | | invention |
| 7-2 | C-1 | 1.0 | Compound 4 | 5 | Sumilizer | 0.25 | D-VII-3 | 3 | This |
| | | | | | BP-76 | | | | invention |
| 7-3 | C-1 | 1.0 | Compound 4 | 30 | Sumilizer | 0.25 | D-VII-3 | 3 | This |
| | | | | | BP-76 | | | | invention |
| 7-4 | C-1 | 1.0 | Compound 4 | 0.5 | Sumilizer | 0.25 | D-VII-3 | 3 | Comparative |
| | | | | | BP-76 | | | | example |
| 7-5 | C-1 | 1.0 | Compound 4 | 50 | Sumilizer | 0.25 | D-VII-3 | 3 | Comparative |
| | | | | | BP-76 | | | | example |
| 7-6 | C-1 | 1.0 | Compound 12 | 5 | Tinuvin | 0.01 | Vicoflex | 3 | This |
| | | | | | 120 | | 5075 | | invention |
| 7-7 | C-1 | 1.0 | Compound 12 | 5 | Tinuvin | 0.25 | Vicoflex | 3 | This |
| | | | | | 120 | | 5075 | | invention |
| 7-8 | C-1 | 1.0 | Compound 12 | 5 | Tinuvin | 5 | Vicoflex | 3 | This |
| | | | | | 120 | | 5075 | | invention |
| 7-9 | C-1 | 1.0 | Compound 12 | 5 | Tinuvin | 0.003 | Vicoflex | 3 | Comparative |
| | | | | | 120 | | 5075 | | example |
| 7-10 | C-1 | 1.0 | Compound 12 | 5 | Tinuvin | 10 | Vicoflex | 3 | Comparative |
| | | | | | 120 | | 5075 | | example |
| 7-11 | C-1 | 1.0 | Compound 16 | 5 | Irganox | 0.25 | Compound** | 3 | This |
| | | | | | 1010 | | | | invention |
| 7-12 | C-1 | 3.0 | Compound 16 | 5 | Irganox | 0.25 | Compound** | 3 | This |
| | | | | | 1010 | | | | invention |
| 7-13 | C-1 | 4.0 | Compound 16 | 5 | Irganox | 0.25 | Compound** | 3 | Comparative |
| | | | | | 1010 | | | | example |
| 7-14 | C-1 | 1.0 | Di-2- | 8 | Sumilizer | 0.25 | Epon 815c | 0.1 | This |
| | | | ethylhexyl- | | GA-80 | | | | invention |
| | | | adipate | | | | | | |
| 7-15 | C-1 | 1.0 | Di-2- | 8 | Sumilizer | 0.25 | Epon 815c | 3 | This |
| | | | ethylhexyl- | | GA-80 | | | | invention |
| | | | adipate | | | | | | |
| 7-16 | C-1 | 1.0 | Di-2- | 8 | Sumilizer | 0.25 | Epon 815c | 10 | This |
| | | | ethylhexyl- | | GA-80 | | | | invention |
| | | | adipate | | | | | | |
| 7-17 | C-1 | 1.0 | Di-2- | 8 | Sumilizer | 0.25 | Epon 815c | 0.05 | Comparative |
| | | | ethylhexyl- | | GA-80 | | | | example |
| | | | adipate | | | | | | |
| 7-18 | C-1 | 1.0 | Di-2- | 8 | Sumilizer | 0.25 | Epon 815c | 20 | Comparative |
| | | | ethylhexyl- | | BP-76 | | | | example |
| | | | adipate | | | | | | |
| 7-19 | C-1 | 1.0 | Dioctyl | 8 | Sumilizer | 0.25 | Epon 815c | 3 | This |
| | | | sepacate | | GA-80 | | | | invention |
| 7-20 | C-2 | 1.0 | Compound 12 | 5 | Sumilizer | 0.25 | D-VII-3 | 3 | This |
| | | | | | GA-80 | | | | invention |
| 7-21 | C-2 | 1.0 | Dioctyl | 8 | Irganox | 0.25 | Epon 815c | 3 | This |
| | | | sepacate | | 1010 | | | | invention |

D-VII-3 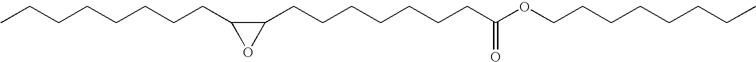
Vicoflex 5075 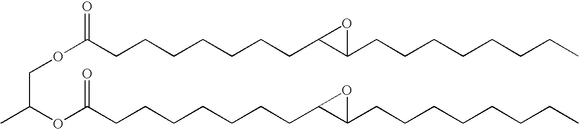
Compound** 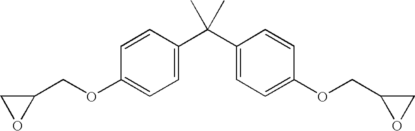
2,2-bis(glycidyloxyphenyl)propane
(being diglycidyl ether of Bis Phenol A)

TABLE 8

| | | | Luminescent | |
|---|---|---|---|---|
| Sample | | Dimensional | Point Foreign | |
| No. | Haze | Stability | Material | Remarks |
| 7-1 | B | B | B | This invention |
| 7-2 | B | B | B | This invention |
| 7-3 | B | B | B | This invention |
| 7-4 | C | D | D | Comparative |
| | | | | example |
| 7-5 | D | C | C | Comparative |
| | | | | example |
| 7-6 | B | B | B | This invention |
| 7-7 | B | B | B | This invention |
| 7-8 | B | B | B | This invention |
| 7-9 | C | D | D | Comparative |
| | | | | example |
| 7-10 | D | D | D | Comparative |
| | | | | example |
| 7-11 | B | A | A | This invention |
| 7-12 | B | B | B | This invention |
| 7-13 | DD | DD | D | Comparative |
| | | | | example |
| 7-14 | A | B | B | This invention |
| 7-15 | A | B | B | This invention |
| 7-16 | B | B | B | This invention |
| 7-17 | C | C | C | Comparative |
| | | | | example |
| 7-18 | D | C | C | Comparative |
| | | | | example |
| 7-19 | A | B | B | This invention |
| 7-20 | B | B | B | This invention |
| 7-21 | A | B | A | This invention |

From Table 8, it is evident that haze and dimensional stability are better, and optical and mechanical properties of the inventive samples are superior when compared with those of the comparative samples.

### Example 8

### Preparation and Evaluation of Polarizing Plate Protective Film

Optical film samples 7-21A, 7-21B and 7-21C were obtained from optical film sample 7-21 which was prepared using sample 7-1 of Table 7 instead of sample 1-1 of Table 1 in the same manner as in preparation and evaluation of the polarizing film of example 2. These samples had favorable coating properties without brushing occurring or with out any cracking after drying. In addition, it was confirmed that samples corresponding to 7-21A, 7-21B and 7-21C from other inventive samples in Table 7 all have favorable coating properties.

For comparison, optical film samples 7-24A, 7-24B, 7-24C are obtained from the optical film 7-24 which was prepared in the same manner using sample 7-4 in Table 7. The results reveal that when coating was done in a high humidity environment, brushing occurred in sample 7-24A. Also, in the sample 7-24B, fine cracks after drying were sometimes seen and in sample 7-24C fine cracks after drying were obvious.

### [Preparation and Evaluation of Polarizing Plate]

Inventive polarizing plates and the comparative polarizing plates were prepared in the same manner using the samples in Table 7 based on the preparation and evaluation of the polarizing plate in example 2, and the inventive polarizing plates had superior optical and physical properties and a more favorable degree of polarization when compared with the comparative polarizing plates.

### [Evaluation of Properties as a Liquid Crystal Display Device]

The 15-inch TFT color liquid crystal display was prepared in the same manner as in example 2, and the properties as the polarizing plate of a cellulose ester film were evaluated, and in the inventive polarizing plates prepared as described above, as expected, the contrast was higher and the display properties were superior when compared to comparative polarizing plates also prepared as described above. This confirms that the inventive polarizing plates are excellent as the polarizing plate for an image display device such as a liquid crystal display.

### Example 9

Cellulose ester film sample 9-1 was prepared in the same manner as the cellulose ester film sample 1-1 of example 1, except that 0.25 parts by weight of Tinuvin 770 and 3 parts by weight of D-V11-3 were used in place of 0.5 parts by weight of Sumilizer BP-76. Also inventive cellulose ester film samples 9-2, 9-3, 9-6, 9-7, 9-8, 9-11, 9-12, 9-14, 9-15, 9-16, 9-19, 9-20, and 9-21 and comparative cellulose ester film samples 9-4, 9-5, 9-9, 9-10, 9-13, 9-17 and 9-18 were prepared using exactly the same method except that the type of cellulose ester, the water content, the type of additive and the amount of additive are changed as shown in Table 9. The evaluation was also carried out in the same manner as example 1.

TABLE 9

| | | Water | | Amount | | Amount | | Amount | |
|---|---|---|---|---|---|---|---|---|---|
| | Cellu- | Content | | (parts | | (parts | | (parts | |
| Sample | lose | (weight | | by | Hindered | by | Acid | by | |
| No. | Ester | %) | Plasticizer | weight) | Phenol | weight) | scavenger | weight) | Remarks |
| 9-1 | C-1 | 1.0 | Compound 4 | 1 | Tinuvin | 0.25 | D-VII-3 | 3 | This |
| | | | | | 770 | | | | invention |
| 9-2 | C-1 | 1.0 | Compound 4 | 5 | Tinuvin | 0.25 | D-VII-3 | 3 | This |
| | | | | | 770 | | | | invention |
| 9-3 | C-1 | 1.0 | Compound 4 | 30 | Tinuvin | 0.25 | D-VII-3 | 3 | This |
| | | | | | 770 | | | | invention |
| 9-4 | C-1 | 1.0 | Compound 4 | 0.5 | Tinuvin | 0.25 | D-VII-3 | 3 | Comparative |
| | | | | | 770 | | | | example |
| 9-5 | C-1 | 1.0 | Compound 4 | 50 | Tinuvin | 0.25 | D-VII-3 | 3 | Comparative |
| | | | | | 770 | | | | example |
| 9-6 | C-1 | 1.0 | Compound 12 | 5 | CHIMASORB | 0.01 | Vicoflex | 3 | This |
| | | | | | 944LD | | 5075 | | invention |
| 9-7 | C-1 | 1.0 | Compound 12 | 5 | CHIMASORB | 0.25 | Vicoflex | 3 | This |
| | | | | | 944LD | | 5075 | | invention |
| 9-8 | C-1 | 1.0 | Compound 12 | 5 | CHIMASORB | 5 | Vicoflex | 3 | This |
| | | | | | 944LD | | 5075 | | invention |
| 9-9 | C-1 | 1.0 | Compound 12 | 5 | CHIMASORB | 0.003 | Vicolex | 3 | Comparative |
| | | | | | 944LD | | 5075 | | example |
| 9-10 | C-1 | 1.0 | Compound 12 | 5 | CHIMASORB | 10 | Vicoflex | 3 | Comparative |
| | | | | | 944LD | | 5075 | | example |
| 9-11 | C-1 | 1.0 | Compound 16 | 5 | ADKSTAB | 0.25 | Compound** | 3 | This |
| | | | | | LA-52 | | | | invention |
| 9-12 | C-1 | 3.0 | Compound 16 | 5 | ADKSTAB | 0.25 | Compound** | 3 | This |
| | | | | | LA-52 | | | | invention |
| 9-13 | C-1 | 4.0 | Compound 16 | 5 | ADKSTAB | 0.25 | Compound** | 3 | Comparative |
| | | | | | LA-52 | | | | example |
| 9-14 | C-1 | 1.0 | Di-2- | 8 | CHIMASORB | 0.25 | Epon 815c | 0.1 | This |
| | | | ethylhexyladipate | | 2020FDL | | | | invention |
| 9-15 | C-1 | 1.0 | Di-2- | 8 | CHIMASORB | 0.25 | Epon 815c | 3 | This |
| | | | ethylhexyladipate | | 2020FDL | | | | invention |
| 9-16 | C-1 | 1.0 | Di-2- | 8 | CHIMASORB | 0.25 | Epon 815c | 10 | This |
| | | | ethylhexyladipate | | 2020FDL | | | | invention |
| 9-17 | C-1 | 1.0 | Di-2- | 8 | CHIMASORB | 0.25 | Epon 815c | 0.05 | Comparative |
| | | | ethylhexyladipate | | 2020FDL | | | | example |
| 9-18 | C-1 | 1.0 | Di-2- | 8 | CHIMASORB | 0.25 | Epon 815c | 20 | Comparative |
| | | | ethylhexyladipate | | 2020FDL | | | | example |
| 9-19 | C-1 | 1.0 | Dioctyl sepacate | 8 | CHIMASORB | 0.25 | Epon 815c | 3 | This |
| | | | | | 2020FDL | | | | invention |
| 9-20 | C-2 | 1.0 | Compound 12 | 5 | Tinuvin | 0.25 | D-VII-3 | 3 | This |
| | | | | | 770 | | | | invention |
| 9-21 | C-2 | 1.0 | Dioctyl sepacate | 8 | CHIMASORB | 0.25 | Epon 815c | 3 | This |
| | | | | | 2020FDL | | | | invention |

TABLE 10

| | | | Luminescent | |
|---|---|---|---|---|
| Sample | | Dimensional | Point of Foreign | |
| No. | Haze | Stability | Material | Remarks |
| 9-1 | A | B | B | This invention |
| 9-2 | A | B | B | This invention |
| 9-3 | B | B | B | This invention |
| 9-4 | C | D | D | Comparative |
| | | | | example |
| 9-5 | D | C | C | Comparative |
| | | | | example |
| 9-6 | B | B | B | This invention |
| 9-7 | B | A | B | This invention |
| 9-8 | B | B | B | This invention |
| 9-9 | C | D | D | Comparative |
| | | | | example |
| 9-10 | D | D | D | Comparative |
| | | | | example |
| 9-11 | B | A | A | This invention |
| 9-12 | B | B | B | This invention |
| 9-13 | DD | DD | D | Comparative |
| | | | | example |
| 9-14 | B | B | B | This invention |
| 9-15 | B | B | B | This invention |
| 9-16 | B | B | B | This invention |
| 9-17 | C | C | C | Comparative |
| | | | | example |
| 9-18 | D | C | C | Comparative |
| | | | | example |
| 9-19 | B | B | B | This invention |
| 9-20 | A | B | B | This invention |
| 9-21 | B | B | A | This invention |

From Table 10, it is evident that haze and dimensional stability are better, and optical and mechanical properties of the invention samples are superior when compared to those of the comparative samples.

### Example 10

### Preparation and Evaluation of Polarizing Plate Protective Film

Optical film samples 9-21A, 9-21B and 9-21C were obtained from optical film sample 9-21 which was prepared using sample 9-1 of Table 9 instead of sample 1-1 of Table 1 in the same manner as in preparation and evaluation of the polarizing film of example 2. These samples exhibited favorable coating properties without brushing or without any cracking after drying. In addition, it was confirmed that all samples corresponding to 9-21A, 9-21B and 9-21C from other inventive samples in Table 9 exhibited favorable coating properties.

For comparison, optical film samples 9-24A, 9-24B, 9-24C were obtained from optical film 9-24 which was prepared in the same manner using sample 9-4 in Table 9. The results reveal that when coating was done in a high humidity environment, brushing occurred in sample 9-24A. Also, in the sample 9-24B, fine cracks after drying were sometimes noted and in sample 9-24C fine cracks after drying were obvious.

### [Preparation and Evaluation of Polarizing Plate]

Inventive polarizing-plates and comparative polarizing plates were prepared in the same manner using the samples in Table 9 based on the preparation and evaluation of the polarizing plate in example 2, and the inventive polarizing plates exhibited superior optical and physical properties and a more favorable degree of polarization when compared to the comparative polarizing plates.

### [Evaluation of Properties as a Liquid Crystal Display Device]

The 15-inch TFT color liquid crystal display was prepared in the same manner as in example 2, and the properties as the polarizing plate of a cellulose ester film were evaluated, which showed as expected that in the inventive polarizing plates prepared as above, the contrast was higher and the display properties were excellent when compared to comparative polarizing plates also prepared as above. This confirms that the inventive polarizing plates are excellent as the polarizing plate for an image display device such as a liquid crystal display.

### Example 11

Cellulose ester film sample 11-1 was prepared in the same manner as cellulose ester film sample 1-1 of example 1, except that 5 parts by weight of compound 4, 0.1 part by weight of Sumilizer BP-76, 0.1 part by weight of =Tinuvin 770 and 3 parts by weight of D-VII-3 were used instead of 1 part by weight of compound 4 and 0.5 part by weight of Sumilizer BP-76. Also, inventive cellulose ester film samples 11-2, 11-3, 11-4, 11-5, 11-6, and 11-7 were prepared using the same method except that the type of cellulose ester, the water content, the type of additive and the amount of additive were changed as shown in Table 11. The evaluation was also carried out in the same manner as example 1.

C-3: Cellulose acetate propionate (at degree of acetyl group substitution of 1.9, degree of propionyl group substitution of 0.8, molecular weight Mn of 70,000, molecular weight Mw=220,000, and Mw/Mn of 3)

C-4: Cellulose triacetate

TABLE 11

| | | Water | | | | Amount | | Amount | | Amount | |
|---|---|---|---|---|---|---|---|---|---|---|---|
| | | Content | | Amount | | (part | | (part | | (part | |
| Sample | | (weight | Plasti- | (part by | | by | | by | | by | |
| No. | *1 | %) | cizer | weight) | *2 | weight) | *3 | weight) | *4 | weight) | Remarks |
| 11-1 | C-1 | 1.0 | Compound | 1 | *7 | 0.1 | *11 | 0.1 | D-VII-3 | 3 | This |
| | | | 4 | | | | | | | | invention |
| 11-2 | C-2 | 1.0 | Compound | 5 | *8 | 0.1 | *12 | 0.1 | Vicoflex | 3 | This |
| | | | 4 | | | | | | 5075 | | invention |
| 11-3 | C-3 | 1.0 | Compound | 30 | *9 | 0.1 | *13 | 0.1 | Compound** | 3 | This |
| | | | 16 | | | | | | | | invention |
| 11-4 | C-4 | 1.0 | *5 | 0.5 | *10 | 0.1 | *14 | 0.1 | Epon 815c | 3 | This |
| | | | | | | | | | | | invention |
| 11-5 | C-4 | 1.0 | *6 | 50 | *10 | 0.1 | *14 | 0.1 | Epon 815c | 3 | This |
| | | | | | | | | | | | invention |
| 11-6 | C-3 | 1.0 | Compound | 5 | *7 | 0.1 | *11 | 0.1 | D-VII-3 | 3 | This |
| | | | 16 | | | | | | | | invention |
| 11-7 | C-3 | 1.0 | *6 | 5 | *9 | 0.1 | *14 | 0.1 | Epon 815c | 3 | This |
| | | | | | | | | | | | invention |

*1: Cellulose ester,
*2: Hindered phenol,
*3: Hindered amine,
*4: Acid scavenger,
*5: Di-2-ethylhexyladipate,
*6: Dioctylsepacate,
*7: Sumilizer BP-76,
*8: Tinuvin 120,
*9: Irganox 1010,
*10: Sumilizer GA-80,
*11: Tinuvin 770,
*12: CHIMASORB 944LD,
*13: ADKSTAB LA-52,
*14: CHIMASORB 2020FDL

TABLE 12

| | | | Luminescent | |
|---|---|---|---|---|
| Sample | | Dimensional | Point of Foreign | |
| No. | Haze | Stability | Material | Remarks |
| 11-1 | B | B | A | This invention |
| 11-2 | B | B | B | This invention |
| 11-3 | A | A | A | This invention |
| 11-4 | A | B | B | This invention |
| 11-5 | A | B | B | This invention |
| 11-6 | A | B | B | This invention |
| 11-7 | A | A | B | This invention |

From Table 12, it is evident that the inventive samples are superior in haze and dimensional stability, and optical and mechanical properties of them are excellent.

1-8. (canceled)

9. A cellulose ester film manufactured with a manufacturing method comprising the steps of:
1) mixing a cellulose ester exhibiting a water content of not greater than 3.0 weight %, at least one plasticizer selected from the following groups of A and B in an amount of one to thirty weight % of the cellulose ester, and at least one additive selected from the groups of C and D in an amount of 0.01 to 5 weight % of the cellulose ester to obtain a mixture,
group A: ester plasticizers formed from a polyhydric alcohol and a monohydric carboxylic acid
group B: ester plasticizers formed from a polyhydric carboxylic acid and a monohydric alcohol
group C: hindered phenol anti-oxidants
group D: hindered amine light stabilizers
2) heating to melt the mixture at a temperature (Tm) of between 150 and 300° C., and
3) forming the cellulose ester film with a melt casting method employing the melted mixture.

10. An optical film comprising the cellulose ester film, wherein at least one layer selected from the group consisting of an anti-static layer, a hard coat layer, an antireflection layer, a contact facilitating layer, an antiglare layer, and an optical compensation layer is applied on at least one side of the cellulose ester film of claim 9.

11. A polarizing plate, wherein the cellulose ester film of claim 9 is applied on at least one side of the polarizing plate.

12. The polarizing plate, wherein the optical film of claim 10 is applied on at least one side of the polarizing plate.

13. A liquid crystal display device comprising the polarizing plate of claim 11.

14. The liquid crystal display device comprising the optical film of claim 12.
